(19) United States
(12) Patent Application Publication
(10) Pub. No.: US 2023/0419574 A1
(43) Pub. Date: Dec. 28, 2023

(54) INFORMATION PROCESSING APPARATUS AND CONTROL METHOD THEREFOR

(71) Applicant: CANON KABUSHIKI KAISHA, Tokyo (JP)

(72) Inventors: TAKAYUKI YAMADA, Kanagawa (JP); SHINJIRO HORI, Kanagawa (JP); KOUTA MURASAWA, Kanagawa (JP); KAZUYA OGASAWARA, Kanagawa (JP)

(21) Appl. No.: 18/342,421

(22) Filed: Jun. 27, 2023

(30) Foreign Application Priority Data
Jun. 28, 2022 (JP) 2022-104048

(51) Int. Cl. G06T 11/60; G06T 11/00

(52) U.S. Cl. CPC G06T 11/60; G06T 11/001

(57) ABSTRACT

A poster is created such that the poster represents an impression intended by a user, and matching between an image, and an overall color scheme of the poster is achieved.

### BACKGROUND OF THE DISCLOSURE

### Field of the Disclosure

The present disclosure relates to a technique for creating a poster.

### Description of the Related Art

Traditionally, a method has been proposed to create a poster by preparing a template including information about shapes and positions of images, text, and graphics that make up the poster, and automatically arranging the images, text, and graphics according to the template.

Japanese Patent No. 6958096 discloses an apparatus configured to identify color schemes using both representative colors of an image and words indicating sensitivity.

In the technique disclosed in Japanese Patent No. 6958096, color schemes that match a sensory word and an image are identified, but no consideration is given to whether the overall impression of the poster created based on them properly matches an impression intended by the user.

### SUMMARY OF THE DISCLOSURE

In view of the above, the present disclosure provides a technique for properly creating a poster that matches a user's intended impression while also achieving matching between an image and an overall color scheme of the poster.

According to the present disclosure, there is provided an information processing apparatus including at least one processor, and a memory that stores a program which, when executed by the at least one processor, causes the at least one processor to function as an image acquisition unit configured to acquire an image, an accepting unit configured to accept a target impression from a user, a selection unit configured to select a color scheme pattern based on a color included in the image and the target impression, and a poster creation unit configured to create a poster based on the image and the color scheme pattern.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of an information processing apparatus.

FIG. 2 is a software block diagram of a poster creation application.

FIG. 3A is a diagram illustrating an example of a skeleton, and FIG. 3B is a diagram illustrating an example of metadata.

FIG. 4 is a diagram illustrating color scheme patterns.

FIG. 5 is a diagram illustrating a display screen provided by a poster creation application.

FIG. 6 is a diagram illustrating a display screen provided by a poster creation application.

FIG. 7 is a flowchart illustrating a process of quantifying a poster impression in a poster creation process.

FIG. 8 is a diagram illustrating a subjective evaluation of a poster.

FIG. 9 is a flowchart illustrating a poster creation process.

FIGS. 10A to 10C are diagrams illustrating a skeleton selection method.

FIG. 11A is a diagram illustrating color scheme patterns, and FIG. 11B is a diagram illustrating a font selection method.

FIG. 12 is a software block diagram illustrating details of a layout unit.

FIG. 13 is a flowchart illustrating a layout process.

FIGS. 14A to 14C are diagrams illustrating inputs to a layout unit.

FIGS. 15A to 15E are diagrams illustrating an operation of a layout unit.

FIGS. 16A to 16D are diagrams illustrating examples of target impression specification units.

FIG. 17 is a software block diagram of a poster creation application.

FIG. 18 is a flowchart illustrating a poster creation process.

FIGS. 19A to 19D are diagrams for illustrating a combination generation unit.

FIGS. 20A and 20B are diagrams for illustrating a combination generation unit.

FIG. 21 is a software block diagram of a poster creation application.

FIG. 22 is a flowchart illustrating a poster creation process.

FIG. 23 is a diagram for illustrating a main color extraction process.

FIGS. 24A to 24H are diagrams illustrating a color scheme assignment process.

FIG. 25 is a software block diagram of a poster creation application.

FIG. 26 is a flowchart illustrating a poster creation process.

FIG. 27 is a software block diagram illustrating details of a layout unit.

FIG. 28 is a flowchart illustrating a layout process.

FIGS. 29A and 29B are diagrams for illustrating an image selection process.

### DESCRIPTION OF THE EMBODIMENTS

Embodiments of the present disclosure are described in detail below with reference to the drawings. The following embodiments are not intended to limit the scope of the disclosure, which is defined in the claims, and not all of the combinations of features described in the embodiments are essential to the disclosure. The same reference numbers are used for the same constituent elements, and duplicated descriptions thereof are omitted.

### First Embodiment

A first embodiment discloses, by way of example, a method of automatically creating a poster by operating an application for creating a poster in an information processing apparatus. In the following description, unless otherwise specified, an “image” refers to a still image or a frame image extracted from a moving image.

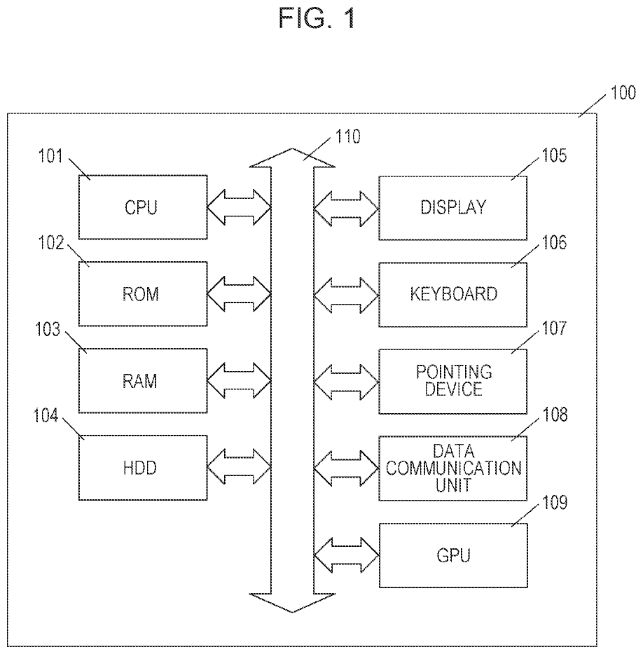

FIG. 1 is a block diagram illustrating a hardware configuration of an information processing apparatus. Examples of the information processing apparatus 100 include a personal computer (hereinafter referred to as “PC”), a smartphone, and the like. In the following description of the present embodiment, it is assumed that the information processing apparatus is a PC. The information processing apparatus 100 includes a CPU 101, a ROM 102, a RAM 103, an HDD 104, a display 105, a keyboard 106, a pointing device 107, and a data communication unit 108.

The CPU (central processing unit/processor) 101 comprehensively controls the information processing apparatus 100 and realizes operations according to the present embodiment, for example, by reading a program stored in the ROM 102 into the RAM 103 and executing it. Although only one CPU is shown in FIG. 1, there may be a plurality of CPUs. The ROM 102 is a general-purpose ROM and stores, for example, a program to be executed by the CPU 101. The RAM 103 is a general-purpose RAM and is used, for example, as a working memory to temporarily store various information when a program is executed by the CPU 101. The HDD (Hard Disk Drive) 104 is a storage medium (a storage unit) for storing image files, a database of results of image analysis and other processing, and skeletons used by the poster creation application.

The display 105 is a display unit that displays a user interface (UI) according to the present embodiment and also displays image data (hereinafter, also referred to as an “image”) as a layout result of an electronic poster to the user. Although not shown in the figure, a display control unit is also provided to control the display on the display unit. The keyboard 106 and the pointing device 107 accept instructional operations from the user.

The display 105 may have a touch sensor function. The keyboard 106 is used, for example, by the user to enter the number of double-page poster sheets to be generated, on the UI shown on the display 105. The pointing device 107 is used, for example, by the user to click a button on the UI displayed on the display 105.

The data communication unit 108 communicates with an external apparatus via a wired or wireless network. For example, the data communication unit 108 transmits data laid out by an automatic layout function to a printer or a server that can communicate with the information processing apparatus 100. The data bus 109 connects the blocks shown in FIG. 1 such that they can communicate with each other.

Note that the configuration shown in FIG. 1 is only an example and is not limited to this. For example, the information processing apparatus 100 may not have the display 105 and may display the UI on an external display.

In the present embodiment, the poster creation application is stored in the HDD 104. As described later, the poster creation application is started when a user selects an application icon displayed on the display 105 with the pointing device 107 and clicks or double-clicks it.

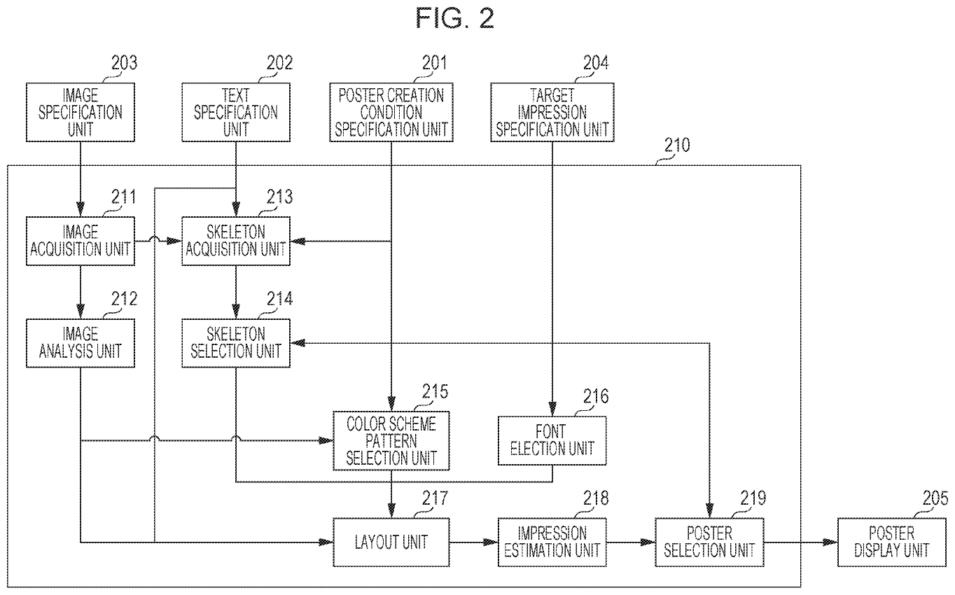

FIG. 2 is a software block diagram of a poster creation application. The poster creation application includes a poster creation condition specification unit 201, an image specification unit 203, a text specification unit 202, a target impression specification unit 204, a poster display unit 205, and a poster creation unit 210. The poster creation unit 210 includes an image acquisition unit 211, an image analysis unit 212, a skeleton acquisition unit 213, a skeleton selection unit 214, a color scheme pattern selection unit 215, a font selection unit 216, a layout unit 217, an impression estimation unit 218, and a poster selection unit 219.

Program modules corresponding to the respective components shown in FIG. 2 are included in the poster creation application described above. By executing these program modules, the CPU 101 realizes the functions of the components shown in FIG. 2. In the following description of the respective components shown in FIG. 2, it is assumed that the corresponding components execute various processes. FIG. 2 shows a software block diagram related, among various units, the poster creation unit 210 that provides the automatic poster creation function.

The poster creation condition specification unit 201 specifies poster creation conditions to the poster creation unit 210 according to UI operations with the pointing device 107. In the present embodiment, the poster size, the number of posters to be created, and the purpose category are specified as the poster creation conditions. The poster size may be specified by actual width and height values, or by a paper size such as A1, A2, or the like. The purpose category indicates what the poster will be used for, such as a restaurant, a school event, sales, etc.

The text specification unit 202 specifies text information to be placed on the poster by a UI operation using the keyboard 106. The text information placed on the poster includes a character string representing, for example, the title, the date and time, the location, and the like. The text specification unit 202 outputs each piece of text information to the skeleton acquisition unit 213 and the layout unit 217 such that each piece of text information is associated with type information indicating a type of information such as title information, date and time information, location information, or the like.

The image specification unit 203 specifies an image group to be placed on the poster from images stored in the HDD 104. The specifying of the image group may be performed by specifying a device or a directory or other similar file system structure where one or more images are stored. Alternatively, accompanying information of individual images such as shooting date and time or attribute information may be specified. The image specification unit 203 outputs the file path of the specified image to the image acquisition unit 211.

The target impression specification unit 204 specifies the target impression of the poster to be created. The target impression is the final impression to be achieved for the poster to be created. In the present embodiment, a degree of an impression to be expressed is specified by performing a UI operation on a word expressing the impression using the pointing device 107.

The image acquisition unit 211 acquires the image group specified by the image specification unit 203 from the HDD 104. The image acquisition unit 211 outputs the acquired image data to the image analysis unit 212, and outputs the number of acquired images to the skeleton acquisition unit 213. Examples of images stored in the HDD 104 are still images and frame images extracted from moving images. The still images and the frame images are obtained from an imaging device such as a digital camera, a smart device or the like. The imaging device may be included in the information processing apparatus 100 or may be included in an external apparatus. Note that when the imaging device is an external apparatus, images are acquired via the data communication unit 108. As other examples, the still image may be an illustration image created by image editing software or a CG image created by CG generation software. The still image and the extracted image may be obtained from a network site or a server via the data communication unit 108 and a network. An example of the image obtained from a network site or a server is a social networking service image (hereinafter referred to as “SNS image”). The program executed by the CPU 101 analyzes the data attached to each image to determine the storage source. SNS images may be acquired from SNS via the application, and acquisition sources may be managed in the application. The images are not limited to those described above, and other types of images may be obtained.

The image analysis unit 212 analyzes the image data acquired from the image acquisition unit 211 by a method described later to acquire an image feature value. The analysis is performed such that object recognition and main color extraction are performed, and image feature values are obtained from them. The image analysis unit 212 associates the image data with the acquired image feature value and outputs them to the color scheme pattern selection unit 215 and the layout unit 217.

The skeleton acquisition unit 213 acquires from the HDD 104 a skeleton group that meets the conditions specified by the poster creation condition specification unit 201, the text specification unit 202, and the image acquisition unit 211. In the present embodiment, the skeleton is information representing the placement of character strings, images, graphics, etc., to placed on the poster.

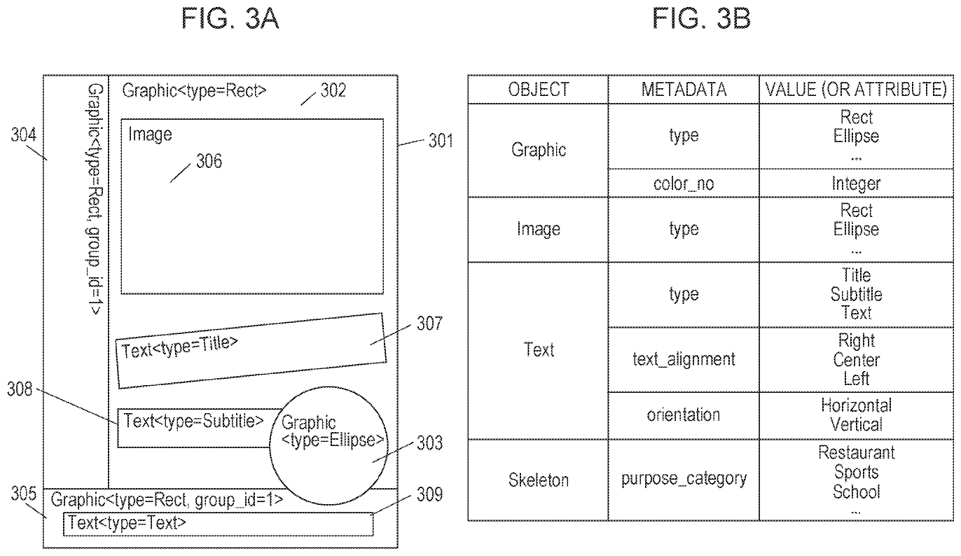

FIGS. 3A and 3B are diagrams for illustrating an example of a skeleton. Four graphic objects 302 to 305, one image object 306, and three text objects 307 to 309 are arranged on the skeleton 301 in FIG. 3A. Each object includes data indicating the position, the size, and the angle, and also metadata required to create a poster. FIG. 3B is a diagram illustrating an example of metadata. For example, text objects 307 to 309 include metadata indicating types of text information placed on the respective text objects. In this example, the metadata indicates that a title is placed on the text object 307, a subtitle is placed on the text object 308, and a main text is placed on the text object 309. Graphic objects 302 to 305 hold metadata indicating graphic shapes, and graphic objects 304 and 305 further hold group IDs. In this example, the metadata indicates that the graphic objects 302, 304, and 305 are rectangles, and the graphic object 303 is an ellipse. The graphic object 304 is assigned 1 as a group ID. The group ID is information to be referred to when a color scheme is assigned, which will be described later. The same color is assigned to the same group ID. Note that the types of objects and metadata are not limited to those described above. For example, there may be a map object for placement of a map, a barcode object for placement of a QR code (registered trademark) or a barcode. As for metadata of text objects, there may be metadata representing the space between lines and the space between characters. The purpose of the skeleton may be described in the metadata and may be used to control whether or not the skeleton is allowed to be used according to the purpose. The impression given by a poster changes depending on the image layout, the text layout, the graphic layout, the text font, the color scheme, the graphics, etc. on the skeleton.

The skeleton may be stored in, for example, a CSV format in the HDD 104, or may be stored in a DB format such as SQL. The skeleton acquisition unit 213 outputs the skeleton group acquired from the HDD 104 to the skeleton selection unit 214.

The skeleton selection unit 214 selects a skeleton group that matches the target impression specified by the target impression specification unit 204 from among the skeletons acquired from the skeleton acquisition unit 213, and outputs the selected skeleton group to the layout unit 217. Since the layout of the entire poster is determined by the skeleton, it is possible to increase the variations of the created posters by preparing various types of skeletons in advance.

The color scheme pattern selection unit 215 acquires, from the HDD 104, a color scheme pattern group that matches the target impression specified by the target impression specification unit 204, and selects a candidate color scheme pattern group based on the main colors of the image acquired from the image analysis unit 212. The color scheme pattern selection unit 215 outputs the selected color scheme pattern group to the layout unit 217. Note that the color scheme pattern refers to a combination of colors used in a poster.

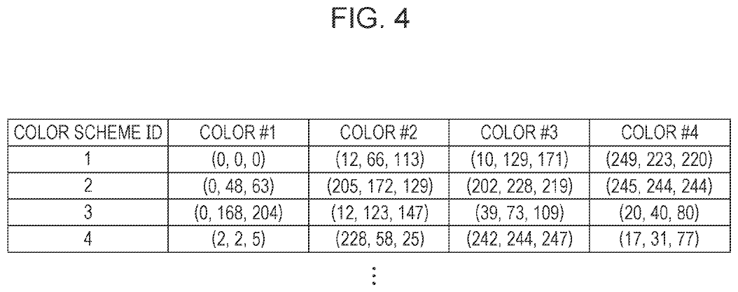

FIG. 4 is a diagram illustrating an example of a table of color scheme patterns. In the present embodiment, the color scheme pattern indicates a combination of four colors. In a color scheme ID column in FIG. 4, IDs each uniquely identifying a color pattern are described. In color #1 to color #4 columns, colors are specified by RGB color values of 0 to 255 wherein the respective RGB color values are described in the order of R, G, B in parentheses. In the present embodiment, each color scheme pattern is given by a combination of four colors, but the number of colors specifying each color scheme pattern is not limited to four. Furthermore, combinations of various numbers of colors may be used to specify color scheme patterns.

The font selection unit 216 acquires, from the HDD 104, a font group that matches the target impression specified by the target impression specification unit 204 and outputs the selected font group to the layout unit 217.

The layout unit 217 generates poster data by laying out various data on each skeleton acquired from the skeleton selection unit 214. The layout unit 217 places, on each skeleton, the text acquired from the text specification unit 202 and the image data acquired from the image analysis unit 212, and applies the color scheme pattern acquired from the color scheme pattern selection unit 216. The layout unit 217 outputs the generated poster data group to the impression estimation unit 218.

The impression estimation unit 218 estimates the impression of each piece of poster data acquired from the layout unit 217 and associates the estimation result with each piece of poster data. The impression estimation unit 218 outputs the estimated impression associated with each piece of poster data to the poster selection unit 219.

The poster selection unit 219 compares the target impression specified by the target impression specification unit 204 with the estimated impression acquired from the impression estimation unit 218, and selects poster data whose distance between the estimated impression and the target impression is smaller than or equal to a threshold value. The threshold value may be incorporated in the poster creation application in advance, or may be specified by the user via the poster creation condition specification unit 201. The selection result is stored in the HDD 104. The poster selection unit 219 outputs the selected poster data to the poster display unit 205.

The poster display unit 205 outputs a poster image to be displayed on the display 105 according to the poster data acquired from the poster selection unit 219. For example, the poster image is represented in bitmap data. The poster display unit 205 displays the poster image on the display 105.

When the poster creation application is installed in the information processing apparatus 100, a start icon is displayed on a top screen (desktop) of an OS (operating system) running on the information processing apparatus 100. When the user double-clicks the start icon displayed on the display 105 with the pointing device 107, the application program stored in the HDD 104 is loaded into the RAM 103 and executed by the CPU 101, and thus the application is started.

Although not shown in the figure, the poster creation application may have a function of editing the created poster after the creation result is displayed on the poster display unit 205 such that the layout, the colors, and, the shapes, etc. of the images, the texts (characters), and the graphics (figures, illustrations, photographs, etc.) are edited according to a user operation so as to achieve a design desired by the user.

When a function is provided that allows it to print poster data stored in the HDD 104 using a printer according to the conditions specified by the poster creation condition specification unit 201, the user can obtain the created poster in the printed form.

### Examples of Display Screens

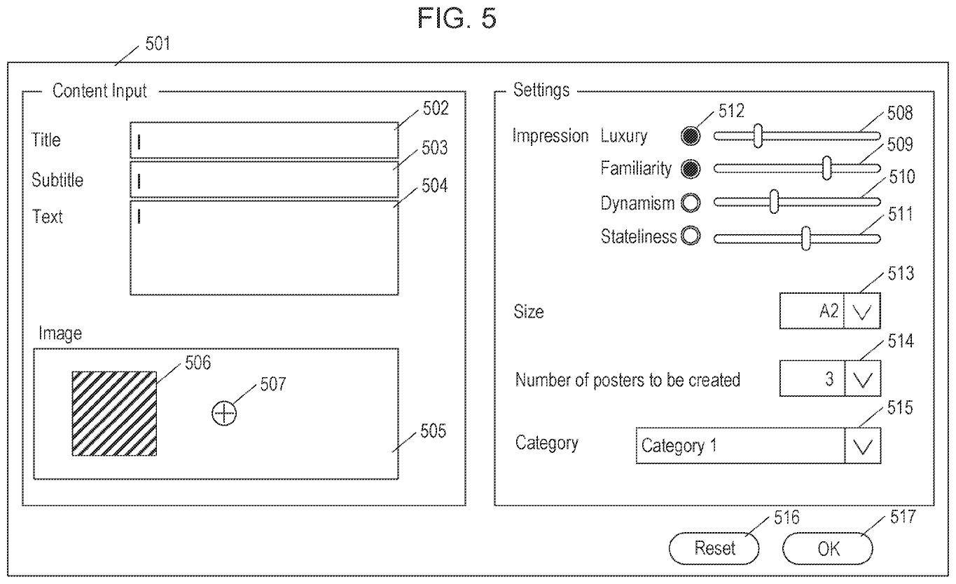

FIG. 5 is a diagram illustrating an example of an application screen 501 provided by the poster creation application. An application screen 501 (a first screen) is displayed on the display 105 when the application is started to provide a screen for accepting a target impression from the user. When the user sets poster creation conditions, text, and images, which will be described later, via the application screen 501, the poster creation condition specification unit 201, the image specification unit 203, and the text specification unit (the text acquisition unit) 202 acquire the content set by the user via the UI screen.

A title box 502, a subtitle box 503, and a main text box 504 accept specifying of text information to be placed on the poster. Three types of text information are accepted in the present embodiment, but this is by way of example and not limitation. For example, additional text information indicating a location, date and time, or the like may be accepted. It is not necessary that all are specified, and some specification boxes may be blank.

An image specification area 505 is an area in which images to be placed on the poster are displayed. An image 506 indicates a thumbnail of a specified image. An image addition button 507 is a button for adding an image to be placed on the poster. When the user presses the image addition button 507, the image specification unit 203 displays a dialog screen for selecting a file stored in the HDD 104 and accepts a selection of an image file from the user. A thumbnail of the selected image is added to the image specification area 507.

Impression sliders 508 to 511 are sliders for setting the target impression of the poster to be created. For example, the impression slider 508 is used to set the target impression in terms of luxury. As the slider is moved to the right, the impression of the poster with respect to luxury increases, and as the slider is moved to the left, the impression of the poster with respect luxury decreases (becomes cheap). For example, when the impression slider 508 is set to the right side and the impression slider 511 is set to the left side, a poster with an impression of high luxury and low stateliness, that is, with an elegant impression, can be created. On the other hand, when the impression slider 511 is set to the right side while the impression slider 508 is kept to the right side, a poster with high luxury and high stateliness, and thus with a gorgeous impression, can be created. As described above, by combining a plurality of impression sliders, it is possible to set the impression in different directions with respect to each impression item such as luxury.

Radio buttons 512 are used to control the enabling/disabling of the setting of the respective target impressions. In the example shown in FIG. 5, luxury and familiarity are set to be enabled, and dynamism and stateliness are set to be disabled. When the radio button 512 is set to be disabled, the control of the corresponding impression is not performed. For example, when a user wants to create a calm poster with low dynamism but does not care about any other impressions, he/she can turn off the radio buttons 512 except for the radio button for the dynamism to create a poster with an impression of low dynamism. Thus, it is allowed to control all target impressions or a part of the target impressions. That is, it is possible to flexibly control the target impressions in the poster creation.

A size list box 513 is a list box for setting the size of the poster to be created. In response to a clicking operation by the user with the pointing device 107, a list of available poster sizes is displayed and the user is allowed to select a desired size.

A number of posters to be created box 514 is used to set the number of posters to be created.

A category list box 515 is used to set the purpose category of the poster to be created.

A reset button 516 is a button for resetting the setting information on the application screen 501.

When the user presses an OK button 517, the poster creation condition specification unit 201, the text specification unit 202, the image specification unit 203, and the target impression specification unit 204 output the settings made on the application screen 501 to the poster creation unit 210. As a result, the poster creation condition specification unit 201 acquires the size of the poster to be created specified in the size list box 513, the number of posters to be created specified in the box 514 for specifying the number of posters to be created, and the purpose category of the poster to be created specified in the category list box 515. The text specification unit 202 acquires text information to be placed on the poster from the title box 503, the subtitle box 503, and the main text box 504. The image specification unit 203 acquires the image file path from which the image to be placed on the poster, specified in the image specification area 505, is available. The target impression specification unit 204 acquires the target impressions of the poster to be created from impression sliders 508 to 511 and radio buttons 512. Note that the poster creation condition specification unit 201, the text specification unit 202, the image specification unit 203, and the target impression specification unit 204 may modify the values set on the application screen 501. For example, the text specification unit 202 may remove unnecessary leading or trailing blank characters from the input text information. The target impression specification unit 204 may shape the values specified by the impression sliders 508 to 511. In the present embodiment, it is assumed that when the slider is set to the leftmost position, the impression has a value of −2, and when it is set to the rightmost position, the impression has a value of +2, and the value is shaped to an integer value in the range from −2 to +2. The shaped values correspond to impressions such that −2 corresponds to “low”, −1 to “rather low”, 0 to “neutral”, +1 to “rather high”, and +2 to “high”. It should be noted that the reason why the values are shaped to −2 to +2 is to match the scale of the estimated impression described below thereby facilitating the distance calculation. The shaping is not limited to the above manner. For example, the values may be shaped to 0 to 1.

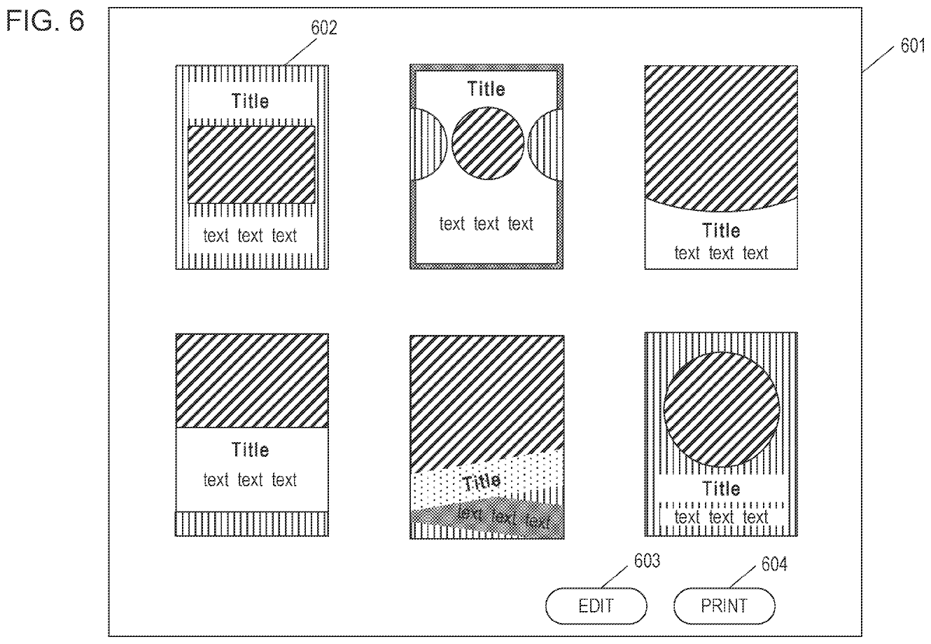

FIG. 6 is a diagram illustrating an example of a poster preview screen displayed on the display 105 and a poster image created by the poster display unit 205 is displayed on the poster preview screen. When an OK button 309 on the application screen 501 is pressed and the poster creating is completed, the screen displayed on the display 105 transitions to the poster preview screen 601.

A poster image 602 is a poster image output by the poster display unit 205. The poster creation unit 210 creates as many posters as specified by the poster creation condition specification unit 201, and thus the created posters are also displayed in the form of a list in the poster image 602. The user can select a poster by clicking a corresponding one of posters with the pointing device 107.

When an edit button 603 is pressed, it becomes possible to edit the selected poster via a UI that provides an edit function (not shown).

A print button 604 allows it to print the selected poster via a control UI of a printer (not shown).

### Quantification of Poster Impression

A method is described below for quantifying the impression of a poster, which is necessary in a poster creation process described later. The poster impression quantification involves quantifying impressions that people have for various posters.

At the same time, the correspondence between the poster image and the impression of the poster is derived. This makes it possible to estimate the impression of the poster from the poster image that will be created. If the impression can be estimated, it becomes possible to control the impression of the poster by correcting the poster, or to search for a poster having a certain target impression. Note that the poster impression quantification process is executed, for example, by operating an impression learning application for learning the poster impression in advance prior to the poster creation process in the information processing apparatus.

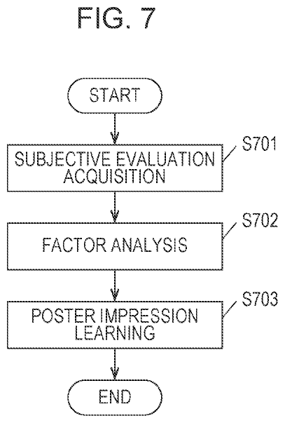

FIG. 7 is a flowchart illustrating a poster impression quantification process. The flowchart shown in FIG. 7 is realized, for example, by the CPU 101 loading a program stored in the HDD 104 into the RAM 103 and executing the program. The poster impression quantification process is described below with reference to FIG. 7. Note that the symbol “S” in the description of each process indicates a step in the flowchart (the same applies hereinafter in this specification).

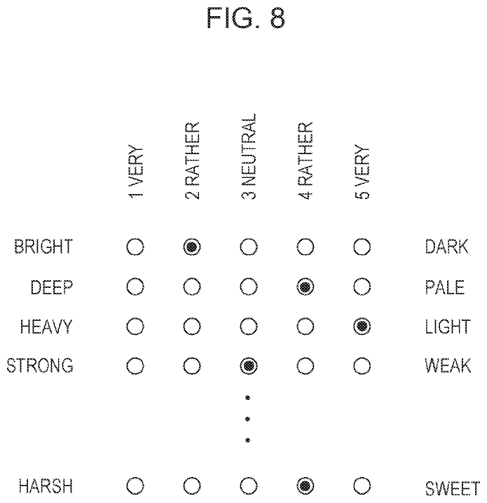

In S701, a subjective evaluation acquisition unit performs a subjective evaluation of the impression of a poster. FIG. 8 is a diagram for explaining an example of a method of a subjective evaluation of an impression of a poster. The subjective evaluation acquisition unit presents the poster to a human evaluator and obtains from the human evaluator a subjective evaluation of the impression of the poster. In the evaluation, a measurement method such as an SD (Semantic Differential) method or a Likert scale method can be used. FIG. 8 illustrates an example of a questionnaire using the SD method, in which adjective pairs expressing impressions are presented to a plurality of human evaluators, and adjective pairs evoked by the target poster are scored. After the subjective evaluation acquisition unit obtains subjective evaluation results from a plurality of human evaluators for a plurality of posters, the subjective evaluation acquisition unit calculates the average value of the responses to each adjective pair, thereby obtaining a representative score value for the corresponding adjective pair. The subjective impression evaluation may be performed by a method other than the SD method, as long as words expressing impressions and the score values corresponding to them can be determined.

In S702, a factor analysis unit performs factor analysis on the subjective evaluation result acquired by the subjective evaluation acquisition unit. When subjective evaluation results are directly used, the number of dimensions is given by the number of adjective pairs, which results in complicate control. Therefore, it is desirable to reduce the number of dimensions to a small value using an analysis technique such as principal component analysis, factor analysis, or the like such that efficient analysis becomes possible. In the following description of the present embodiment, it is assumed that the dimensions are reduced such that the number of factors is reduced to four by factor analysis. Note that the number of factors varies depending on the selection of adjective pairs in the subjective evaluation and the method of factor analysis. It is also assumed that the output of factor analysis is normalized. That is, each factor is scaled to have a mean of 0 and a variance of 1 in the posters used for analysis. As a result, −2, −1, 0, +1, and +2 of the impressions specified by the target impression specification unit 204 can be directly corresponded to −2σ, −1σ, mean value, +1σ, and +2σ in each impression, which makes it easy to calculate the distance between the target impression and the estimated impression, as will be described in further detail later. In the present embodiment, the four factors are luxury, familiarity, dynamism, and stateliness shown in FIG. 5. The names of these factors are given for convenience to convey impressions to the user through the user interface, and each factor is composed of a plurality of adjective pairs that influence each other.

In S703, the impression learning unit associates the poster images with the impressions. Although quantification can be performed for posters subjected to subjective evaluation by the above-described method, it is necessary to estimate the impression of posters that will be created without subjective evaluation. The correspondence between the poster image and the impression can be achieved by learning a model for estimating the impression from the poster image using, for example, a deep learning method using the convolution neural network (CNN) or a machine learning method using a decision tree, or the like. In the present embodiment, the impression learning unit performs supervised deep learning using the CNN with the poster image as input and the four factors as output. That is, subjectively evaluated poster images and corresponding impressions are learned as correct answers to create a deep learning model, and impressions are estimated by inputting an unknown poster image into the learning model.

The deep learning model created above is stored in, for example, the HDD 104, and the impression estimation unit 218 loads the deep learning model stored in the HDD 104 into the RAM 103 and executes it.

The impression estimation unit 218 converts the poster data acquired from the layout unit 217 into an image of the poster and estimates the impression of the poster by causing the CPU 101 or the GPU 109 to operate the deep learning model loaded in the RAM 103. Although the deep learning method is used in the present embodiment, the method is not limited to the deep learning. For example, in a case where a machine learning method such as a decision tree is used, feature values such as an average luminance value, an edge value, and/or the like are extracted from the poster image using image analysis, and a machine learning model may be created which estimates the impression based on these feature values.

### Processing Flow

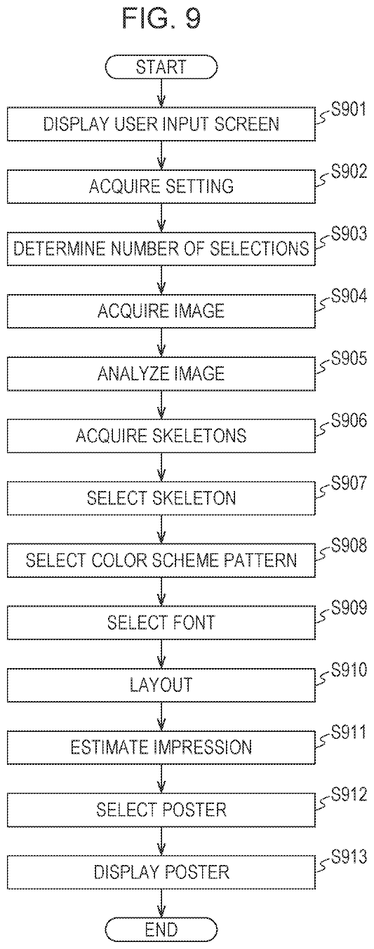

FIG. 9 is a flowchart illustrating a poster creation process performed by the poster creation application. The flowchart shown in FIG. 9 is realized, for example, by the CPU 101 loading a program stored in the HDD 104 into the RAM 103 and executing the program. In the following description of the process shown in FIG. 9, it is assumed that each step of the flow is executed by components shown in FIG. 2 which are realized by the CPU 101 by executing the poster creation application. Referring to FIG. 9, the poster creation process is described below. Note that the symbol “S” in the description of each process indicates a step in the flowchart (the same applies hereinafter in this specification).

In S901, the poster creation application displays the application screen 501 on the display 105. The user inputs each setting using the keyboard 106 or the pointing device 107 via a UI screen of the application screen 501.

In S902, the poster creation condition specification unit 201, the text specification unit 202, the image specification unit 203, and the target impression specification unit 204 acquire settings from the application screen 501.

In S903, the skeleton selection unit 214, the color scheme pattern selection unit 215, and the font selection unit 216 determine the number of skeletons, the number of color scheme patterns, and the number of fonts to be selected according to the number of posters to be created specified by the poster creation condition specification unit 201. In the present embodiment, using a method described later, the layout unit 217 generates poster data for the specified number of skeletons×the specified number of color scheme patterns×the specified number of fonts. The number of skeletons, the number of color scheme patterns, and the number of fonts are set such that the number of posters generated here is greater than the number of posters to be created. In the present embodiment, the number of skeletons, the number of color scheme patterns, and the number of fonts are determined according to equation M2.

$$The number of selections = ⌈ \sqrt[3]{The number of creations \times 2} ⌉ \qquad ( M2 )$$

For example, when the number of posters to be created is 6, the number of selections is 3, the number of pieces of poster data to be generated by the layout unit 217 is 27, and the poster selection unit 219 selects 6 from them.

Thus, the poster selection unit 219 can select posters whose overall impression better matches to the target impression from among the generated poster data whose number of pieces is equal to or greater than the number of posters to be created.

In S904, the image acquisition unit 211 acquires the image data. More specifically, the image acquisition unit 211 reads the image file specified by the image specification unit 203 from the HDD 104 into the RAM 103.

In S905, the image analysis unit 212 performs an object recognition process and a main color extraction process on the image acquired in S904. Here, a known method can be used for the object recognition process. In the present embodiment, an object is recognized by a discriminator generated by deep learning. The discriminator outputs a likelihood value of 0 to 1 as to whether a certain pixel constituting the image is a pixel constituting each object, and recognizes that an object exists in the image when the likelihood value exceeding a certain threshold value. By recognizing the object image, the image analysis unit 212 can acquire the types and positions of objects such as faces, pets such as dogs and cats, flowers, food, buildings, ornaments, and landmarks.

In the main color extraction, the image analysis unit 212 extracts main colors in the image. In the present embodiment, the main colors are identified by detecting colors that appear frequently in the image. FIG. 23 is a diagram that more specifically illustrates the main color extraction. The graph in FIG. 23 is a histogram that schematically represents the frequency of appearance of colors in an image. In this graph, the horizontal axis represents the color of the pixel in three channels (R, G, B), and the vertical axis represents the number of pixels belonging to the range of ±8 before and after each of the R, G, and B channels. For example, a bar of (8, 8, 24) represents the number of pixels that appear in the range from 0 to 16 in the R channel, from 0 to 16 in the G channel, and from 16 to 32 in the B channel. That is, the histogram consists of 16 gradations for each channel and a total of 4096 bins. In this specific example of the embodiment, (248, 248, 216) denoted by reference numeral 2301 in FIG. 23 is the color with the highest appearance frequency, and is extracted as the main color. In the present embodiment, the histogram is generated by dividing the RGB color space into 16 gradations for each channel, but this is by way of example and not limitation. Other numbers of gradations may be used, and other color spaces such as Lab and HSV may be used.

In S906, the skeleton acquisition unit 213 acquires skeletons that meet various setting conditions. In the present embodiment, it is assumed that one skeleton is described in one file and stored in the HDD 104. The skeleton acquisition unit 213 sequentially reads skeleton files from the HDD 104 into the RAM 103, while keeping skeletons that meet the conditions in the RAM 103 and deleting skeletons that do not meet the conditions from the RAM 103. The skeleton acquisition unit 213 first determines whether the size of each poster read into the RAM 103 matches the poster size specified by the poster creation condition specification unit 201. Although in this example it is checked whether the sizes match, it may be checked only whether aspect ratios match.

In this case, the skeleton acquisition unit 213 acquires a skeleton whose size matches the poster size specified by the poster creation condition specification unit 201 when the coordinate system of the read skeleton is properly increased or reduced. Next, the skeleton acquisition unit 213 determines whether the purpose category of the skeleton matches the purpose category specified by the poster creation condition specification unit 201. For skeletons that are used only for a specific purpose, the purpose categories thereof are described in the skeleton files such that the skeletons are not acquired unless the corresponding purpose category is selected. When a skeleton is specifically designed for a specific purpose, for example, as in a case where a graphic image representing school is drawn on a skeleton or as in a case where a graphic image of sports equipment or the like is drawn on a skeleton, such a skeleton is allowed to be used only for the specific purpose and is prevented from being used for other categories. The skeleton acquisition unit 213 then determines whether the number of read-in image objects of the skeleton is equal to the number of images acquired by the image acquisition unit 211. Finally, the skeleton acquisition unit 213 determines whether the text object of the read-in skeleton is matches the text information specified by the text specification unit 202. More specifically, it is determined whether the type of the text information specified by the text specification unit 202 exists on the skeleton. For example, assume that text strings are specified in the title box 502 and the main text box 504 on the application screen 501 and a blank is specified in the subtitle box 503. In this case, all text objects in the skeleton are searched, and if a text object whose type is set as “title” in the metadata and a text object whose type is set as “text” in the metadata are both found, it is determined that the skeleton is suitable, but otherwise it is determined that the skeleton is unsuitable. As described above, the skeleton acquisition unit 213 keeps in the RAM 103 skeletons that match all set conditions in terms of the skeleton size, the number of image objects, and the type of the text object. Although the skeleton acquisition unit 213 checks all skeleton files stored in the HDD 104 in the present embodiment, this is only by way of example and not limitation. For example, the poster creation application may store in the HDD 104 a database that associates file paths of skeleton files with search conditions (the skeleton size, the number of image objects, and types of text objects). In this case, the skeleton acquisition unit 213 searches the database for skeleton files that match the conditions, and the skeleton acquisition unit 213 reads only skeleton files found in the search from the HDD 104 into the RAM 103, which allows it to acquire the skeleton files at a high speed.

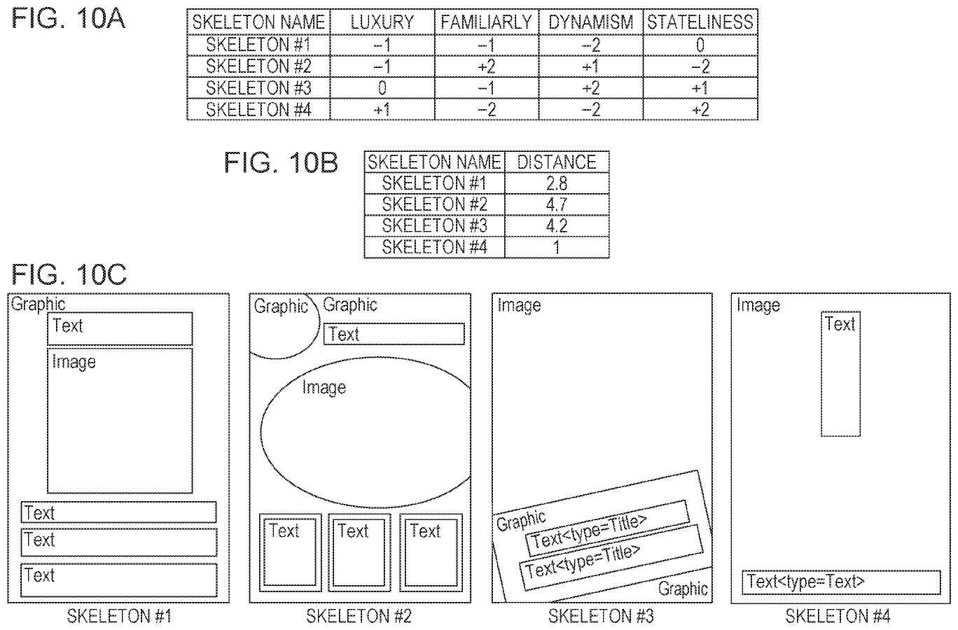

In S907, the skeleton selection unit 214 selects, from the skeletons acquired in S906, skeletons that match the target impression specified by the target impression specification unit 204. FIGS. 10A to 10C are diagrams illustrating a method of selecting skeletons by the skeleton selection unit 214. FIG. 10A is a diagram illustrating an example of a table that associates skeletons with impressions. In FIG. 10A, skeleton file names are described in a skeleton name column. In columns of luxury, familiarity, dynamism, and stateliness, descriptions indicate the degrees to which the skeletons contribute to the respective impressions. First, the skeleton selection unit 214 calculates the distance between the target impression acquired from the target impression specification unit 204 and each impression described in a skeleton impression table shown in FIG. 10A. For example, in a case where the target impression is specified as “luxury=+1, familiarity=−1, dynamism=−2, and stateliness=+2”, the distances are calculated by the skeleton selection unit 214 as shown in FIG. 10B. Note that in the present embodiment, the distance is expressed in the Euclidean distance. Next, the skeleton selection unit 214 selects the top N skeletons with the shortest distances shown in FIG. 8B. In the present embodiment, the skeleton selection unit 214 selects the top two skeletons. That is, skeleton #1 and skeleton #4 are selected.

Note that N may be set to a fixed value, or may be variable according to the condition specified by the poster creation condition specification unit 201. For example, in a case where the number of posters to be created is specified as 6 in the box 514 for specifying the number of posters to be created on the application screen 501, the poster creation unit 210 creates 6 posters. The layout unit 217, which will be described later, generates a poster by combining a skeleton, a color scheme pattern, and a font respectively selected by the skeleton selection unit 214, the color scheme pattern selection unit 215, and the font selection unit 216. For example, in a case where two skeletons, two color scheme patterns, and two fonts are selected, a total of as many posters as 2×2×2=8 are created, which satisfies the condition that the number of posters to be created is 6. As described above, the number of skeletons to be selected may be determined according to the conditions specified by the poster creation condition specification unit 201.

Note that the value range of each impression in the skeleton impression table in FIG. 10A is not necessarily needed to be equal to the value range of the impression specified by the target impression specification unit 204. In the present embodiment, the impression is specified by the target impression specification unit 204 in the value range from −2 to +2, but the value range in the skeleton impression table may be different from this value range. In this case, the distance described above is calculated after the value range of the skeleton impression table is scaled to match that of the target impression. The distance calculated by the skeleton selection unit 214 is not limited to the Euclidean distance, and any distance such as the Manhattan distance, the cosine similarity, or the like may be used as long as it is possible to calculate the distance between vectors. In a case where the radio button 517 is set such that the target impression is set to OFF, the calculation of the distance is not performed.

The skeleton impression table can be generated by, for example, creating posters based on respective skeletons for the fixed color scheme pattern, font, image and text information to be placed on the skeletons, and estimating the impressions of the posters. That is, by estimating the impressions of posters that use the same colors, images, etc., but are different in the layout, it is possible to describe the characteristics relative to other skeletons in the table. In the describing of the characteristics in the table, it is desirable to normalize the impressions based on the overall impression. That is, it is desirable to perform a process to cancel the effects of the used color scheme patterns, images, etc. on the impressions by averaging the impressions of a plurality of posters created using the plurality of color scheme patterns, images, etc. from the one skeleton. This makes it possible to tabulate the impact of the positions on the impression. For example, it is possible to describe that in the case of the skeleton with a small image, the impression is determined by graphic elements or text elements independent of images, or that the tilted placement of images or text provides strong dynamism. FIG. 10C illustrates examples of skeletons respectively corresponding to skeletons #1 to #4 shown in FIG. 10A. For example, in skeleton #1, image objects and text objects are regularly arranged, and the area of the image is small, and thus the dynamism is low. In skeleton #2, the graphic object and the image object are circular, and thus the familiarity is high but the stateliness is low. In skeleton #3, a large image object is placed over a large area and a tilted graphic object is superimposed on the image object, and thus a high dynamism is obtained. In skeleton #4, an image is placed over the entire skeleton, and a text object is placed in a minimized area, and thus a high stateliness is obtained but dynamism is low. As described above, the impression changes depending on the placement of images, graphics, and text. Note that the method of generating the skeleton impression table is not limited to that described above. The impressions may be estimated from features of placement information such as areas and/or coordinates of images or title text. Furthermore, the impressions may be manually adjusted. The skeleton impression table is stored in the HDD 104, and the skeleton selection unit 214 reads out the skeleton impression table from the HDD 104 into the RAM 103 and refers to it.

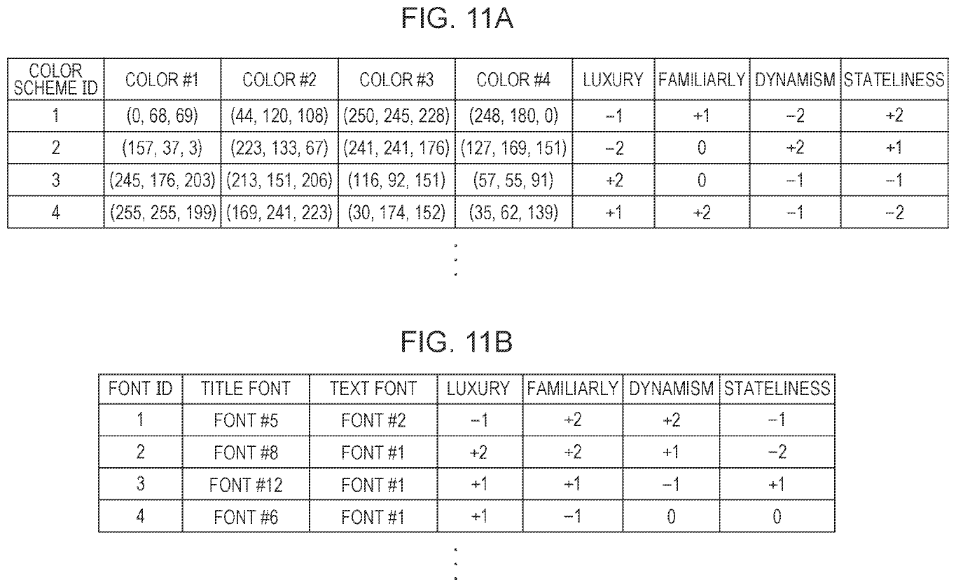

In S908, the color scheme pattern selection unit 215 selects a color scheme pattern based on the colors included in the image acquired in S904 and the target impression input by the user in S901. That is, a color scheme pattern is selected that matches the main color extracted by the image analysis unit 212 and the target impression specified by the target impression specification unit 204. First, the color scheme pattern selection unit 215 selects a color scheme pattern in which the main color obtained from the image analysis unit 212 is included. That is, the color difference is calculated between the main color and each of colors #1 to #4 of each color scheme pattern shown in FIG. 4, and a color scheme pattern is selected that has a color difference smaller than or equal to a threshold value for at least one of the colors #1 to #4. As a result, at least one of the colors assigned to the poster is the same as the main color included in the image. This prevents a mismatch between the colors of the image and the overall colors of the poster, and a sense of unity as a whole of the poster can be achieved. Next, the color scheme pattern selection unit 215 refers to the impression table corresponding to the color scheme pattern as in S906, and selects a color scheme pattern according to the target impression from the color scheme patterns selected based on the main color. FIG. 11A illustrates an example of a color scheme pattern impression table that associates color scheme patterns with impressions. The color scheme pattern selection unit 215 calculates the distance between the target impression and the impression described in the luxury to stateliness columns of the table in FIG. 11A for each color scheme pattern, and selects the top N color scheme patterns with the smallest distance. In the present embodiment, the top two color scheme patterns are selected. As a result, it becomes possible to select a color scheme pattern that well matches the target impression from color scheme patterns that provide a good sense of unity as a whole of the poster. Like the skeleton impression table, the color scheme pattern impression table is obtained by creating posters with various color scheme patterns while fixing the skeleton and the image and estimating the impressions of the resultant posters and tabulating the impression tendencies of the color scheme patterns. In the present embodiment, the main color is given by one color that appears most frequently, but this is only by way of example and not limitation, and a plurality of colors may be extracted as main colors. For example, to extract a second main color, the image analysis unit 212 selects a color that has the second largest local maximum in the three-dimensional (R, G, B) space of the histogram in FIG. 23. For example, for a color of (24, 24, 24), a local maximum can occur when the numbers of pixels of neighboring colors in RGB space, that is, the numbers of pixels of colors of (24, 24, 8), (24, 24, 40), (24, 8, 24), (24, 40, 24), (8, 24, 24), (40, 24, 24) are all smaller than the number of pixels of (24, 24, 24). Note that six or more colors may be taken as neighboring colors. As a result, it is possible to extract not only a color that appears most frequently, but also conspicuous colors that are used as accent colors in the image. The main colors may be extracted based on whether the number of pixels is larger than a threshold value. For example, if the number of pixels at a maximum point in a histogram is greater than 5% of the total number of pixels in an image, the color at that maximum point is extracted as the main color. By obtaining the main color by extracting a color possessed by pixels whose number is greater than or equal to a predetermined value in the manner described above, it is possible to exclude locally conspicuous colors such as noise. Alternatively, the image analysis unit 212 may extract, as main colors, colors possessed by pixels whose number is equal to or greater than a threshold value. In this case, even when similar colors are spread over a large area of an image, such as in a gradation, all similar colors as a whole can be extracted as the main color instead of extracting only one most frequently appearing color. In a case where a plurality of images are specified by the image specification unit 203, the image analysis unit 212 may extract a plurality of main colors by calculating the main color for each image. In a case where two or more main colors are extracted, the color scheme pattern selection unit 215 selects a color scheme pattern including one of the main colors.

In S909, the font selection unit 216 selects a font that matches the target impression specified by the target impression specification unit 204. The font selection unit 216 refers to the impression table corresponding to the font, as in S906, and selects a font according to the target impression. FIG. 11B illustrates an example of a front impression table that associates fonts with impressions. Like the skeleton impression table, the font impression table is obtained by creating posters using various fonts while fixing the skeleton, the color scheme pattern, and the image and estimating the impressions of the resultant posters and tabulating the impression tendencies of the fonts.

In S910, the layout unit 217 sets text information, images, color schemes, and fonts for the skeleton selected by the skeleton selection unit 214, and creates a poster.

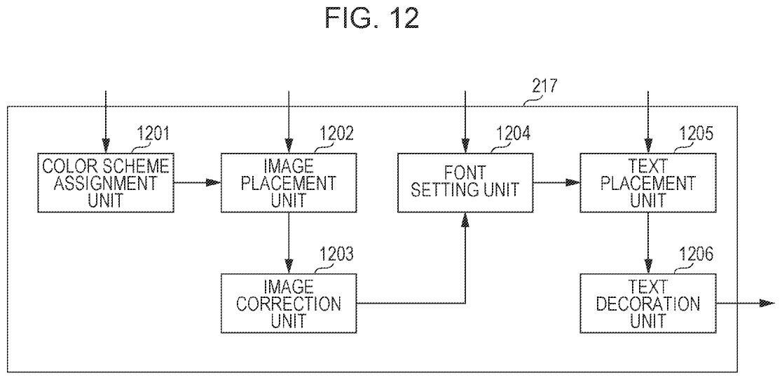

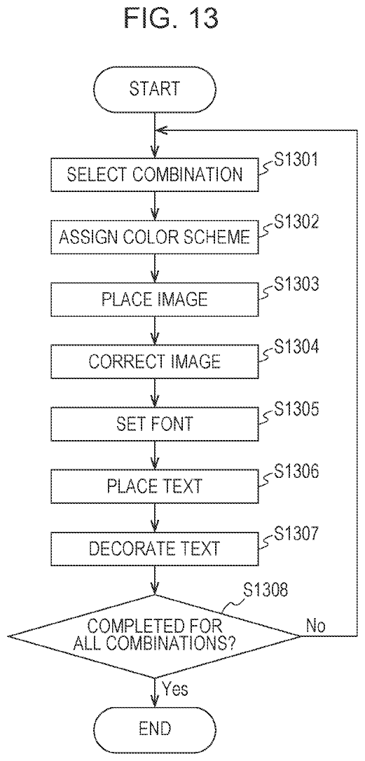

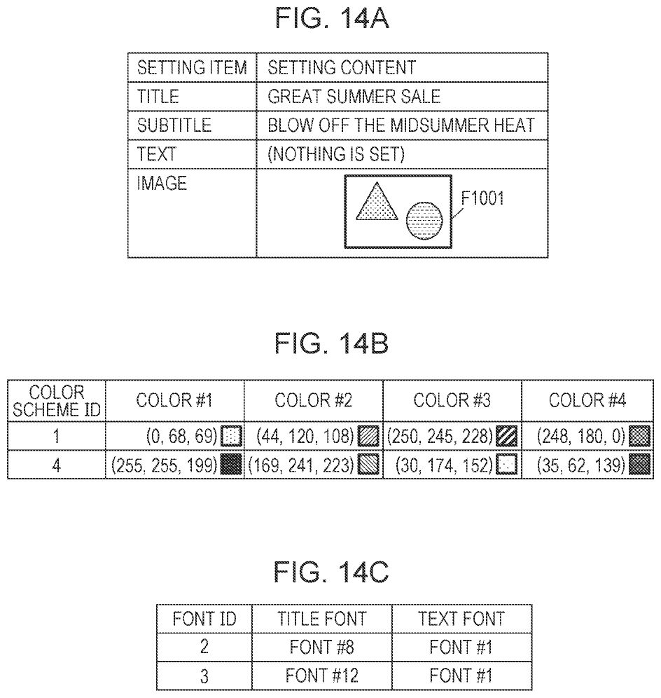

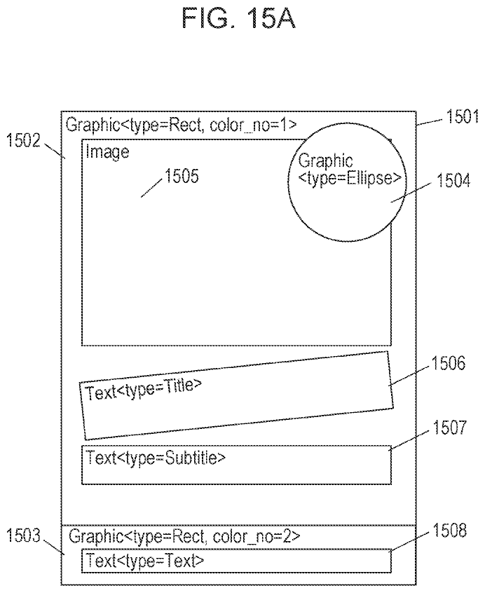

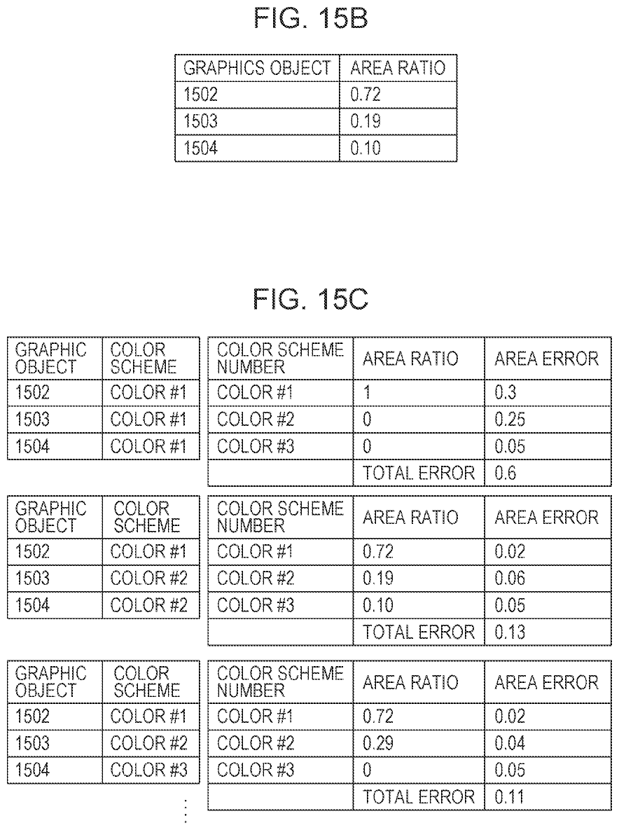

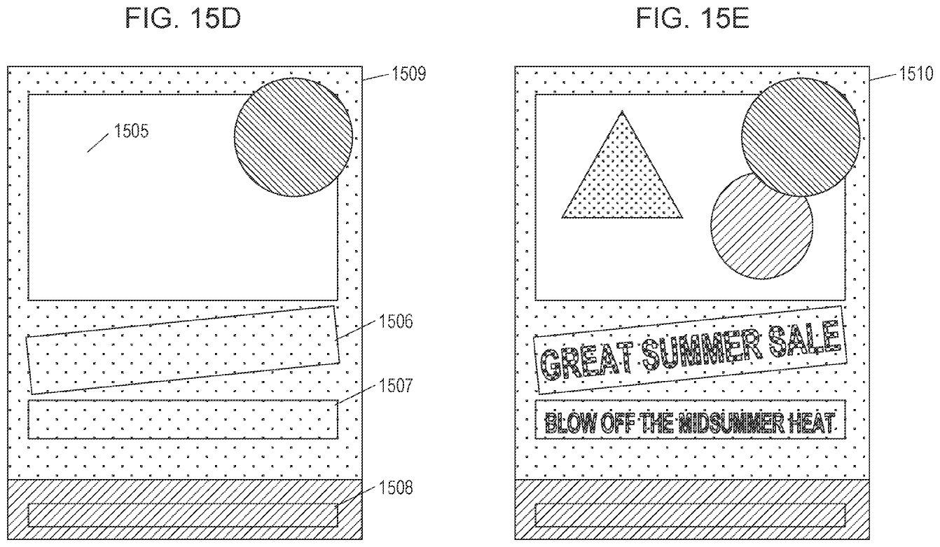

The layout unit 217 and the process in S910 are described in detail below with reference to FIGS. 12A and 12B, FIG. 13, FIGS. 14A to 14C, and FIGS. 15A to 15E. FIG. 12 is a software block diagram illustrating details of the layout unit 217. FIG. 13 is a flowchart illustrating the details of the process in S910. FIGS. 14A to 14C are diagrams illustrating information input to the layout unit 217. FIG. 14A is a table summarizing text information specified by the text specification unit 202 and images specified by the image specification unit 203. FIG. 14B illustrates examples of color scheme patterns acquired by the color scheme pattern selection unit 215. FIG. 14C illustrates examples of fonts acquired from the font selection unit 216. FIGS. 15A to 15E are diagrams illustrating processing steps performed by the layout unit 217.

In S1301, the layout unit 217 lists all combinations of skeletons acquired from the skeleton selection unit 214, color scheme patterns acquired from the color scheme pattern selection unit 215, and fonts acquired from the font selection unit 216. The layout unit 217 sequentially creates poster data for each combination in following layout processing. For example, in a case where the number of skeletons acquired from the skeleton selection unit 214 is 3, the number of color scheme patterns acquired from the color scheme pattern selection unit 215 is 2, and the number of fonts acquired from the font selection unit 216 is 2, the layout unit 217 generates as many pieces of poster data as 3×2×2=12.

In S1302, the color scheme assignment unit 1201 assigns each color scheme pattern acquired from the color scheme pattern selection unit 215 to each skeleton acquired from the skeleton selection unit 214. FIG. 15A is a diagram illustrating an example of a skeleton. In the following description of the present embodiment, it is assumed by way of example that a color scheme pattern with a color scheme ID of 1 shown in FIG. 14B is assigned to a skeleton 1501 shown in FIG. 15A. The skeleton 1501 in FIG. 15A includes three graphic objects 1502 to 1504, one image object 1505, and three text objects 1506 to 1508. First, the color scheme assignment unit 1201 assigns color schemes to the graphic objects 1502 to 1504. In the present example of the embodiment, the color scheme assignment unit 1201 assigns colors such that the ratio between the areas of color #1, color #2, and color #3 of the color scheme pattern is close to a ratio 70:25:5. It is known that a well-balanced design can be easily achieved when colors are assigned such that the color ratio is 70% (base color):25% (main color):5% (accent color), and thus this ratio is used in the present embodiment. In the present embodiment, since the color #4 of the color scheme pattern is assigned to the title text object, this color is not used for the color scheme of graphic objects. This is to achieve the effect of making characters stand out by assigning an accent color to text objects. More specifically, first, the area ratio among all graphic objects is calculated. That is, the area of each graphic object is divided by the total area of all graphic objects. In this dividing process, when an image object or a graphic object overlaps another graphic object in a certain area, and thus the image of the graphic object is invisible in this area, this area is excluded from the area ratio calculation. FIG. 15B shows the area ratio of each of the graphic objects placed on the skeleton 1501. When the colors #1 to #3 are assigned to these graphic objects, the area ratio of each color is calculated. FIG. 15C shows an example of a table that shows color schemes, area ratios in the color schemes, and errors from the target color scheme ratio of 70:25:5. The color schemes and area ratios such as those shown in FIG. 15C are calculated for all combinations, and a combination that provides the smallest area error is determined and the color assignment is performed using the determined combination. In this example, the color #1 is assigned to the graphic object 1502 and the color #2 is assigned to the graphic objects 1503 and 1504.

Next, of the text objects, a text object whose type is specified as “title” in the metadata of the text object is assigned the last color in the color scheme pattern. That is, in the present example, the color #4 is assigned to the text object 1506. Next, of the text objects, a text object whose type is specified as other than “title” in the metadata of the text object is assigned a color determined based on the brightness of the background of the text object. In the present embodiment, if the brightness of the background of the text object is lower than or equal to a threshold value, white is assigned to the text color, but otherwise black is assigned to the text color. FIG. 15D is a diagram showing the state of the skeleton 1509 after the color scheme assignment described above is completed. The color scheme assignment unit 1201 outputs the color-assigned skeleton data to the image placement unit 1202.

In S1303, the image placement unit 1202 places the image data acquired from the image analysis unit 212 on the skeleton data acquired from the color scheme assignment unit 1201 based on the accompanying analysis information. In this example, the image placement unit 1202 assigns the image data 1401 to the image object 1504 on the skeleton. In a case where the image object 1504 and the image data 1401 have different aspect ratios, the image placement unit 1202 performs trimming such that the aspect ratio of the image data 1401 is equal to the aspect ratio of the image object 1504. More specifically, based on the face position and the object position obtained as a result of analyzing the image data 1401 by the image analysis unit 202, the trimming is performed so as to minimize the reduction in the face area and the object area caused by the trimming. Note that the trimming method is not limited to this, and other trimming methods may be used. For example, the center of the image may be trimmed, or a composition is devised such that the face position is in a triangular composition, or the like. The image placement unit 1202 outputs the resultant image-assigned skeleton data to the image correction unit 1203.

In S1304, the image correction unit 1203 acquires the image-assigned skeleton data from the image placement unit 1202, and corrects the images placed on the skeleton. In the present embodiment, when the image resolution is insufficient, upsampling is performed using super-resolution processing. First, the image correction unit 1203 confirms whether the images placed on the skeleton satisfy a predetermined resolution. For example, in a case where an image of 1600 pixels×1200 pixels is assigned to an area of 200 mm×150 mm on the skeleton, the print resolution of the image that will be obtained when the image is printed can be calculated according to equation M1.

$$\frac{1600}{200 \div 25.4} \approx 203 [ dpi ] \qquad ( M 1 )$$

Next, if the print resolution of the image is lower than a threshold value, the image correction unit 1203 compensates for the sense of resolution by super-resolution processing. Conversely, if the resolution is high enough, no particular image correction is performed. In the present embodiment, the super-resolution processing is performed when the resolution is lower than 300 dpi.

In S1305, the font setting unit 1204 sets the font acquired from the font selection unit 216 to the image-corrected skeleton data acquired from the image correction unit 1203. FIG. 10C shows an example of a font selected by the font selection unit 216. In this example, fonts are set for the text objects 1506 and 1507, and 1508. As for fonts of posters, in many cases, a conspicuous font is used for titles to provide high visual attractiveness, while an easy-to-read font is used for other types of text. Therefore, in the present embodiment, the font selection unit 216 selects two types of fonts, that is, a title font and a text font. The font setting unit 1204 sets the title font for the text object 1506 whose type is title, and sets the text font for the other text objects 1507 and 1508. The font setting unit 1204 outputs the font-set skeleton data to a text placement unit 1205. In the present embodiment, the font selection unit 216 selects two types of fonts, but this is only by way of example and not limitation. For example, only the title font may be selected. In this case, the font setting unit 1204 uses a font corresponding to the title font as the text font. That is, for example, in a case where a Gothic family font is used for the title, a Gothic family font that is highly readable may be used for other types of text objects, while in a case where a Mincho family font is used for the title, a Mincho family font may be used for other types of text objects, and so on. Of course, the title font and the text font may be the same. Alternatively, different fonts may be used depending on how prominent the text objects are to be. For example, the title font is used for the title text object and subtitle text objects, the text font is used for the other text objects, the title font is used for text objects described in fonts with a size greater than or equal to a predetermined value.

In S1306, the text placement unit 1205 places the text specified by the text specification unit 202 on the font-set skeleton data acquired from the font setting unit 1204. In the present embodiment, each text shown in FIG. 14A is assigned according to the metadata of each text object of the skeleton. More specifically, the title “GREAT SUMMER SALE” is assigned to the text object 1506, and the subtitle “BLOW OFF THE MIDSUMMER HEAT” is assigned to the text object 1507. Nothing is set to the text, and thus nothing is assigned to the text object 1508. FIG. 15C shows a skeleton 1509, which is an example of skeleton data processed by the text placement unit 1205. The text placement unit 1205 outputs the skeleton data to which the text has been placed to a text decoration unit 1206.

In S1307, the text decoration unit 1206 decorates the text object in the text-placed skeleton acquired from the text placement unit 1205. In the present embodiment, if the color difference between the characters of the title and its background area is smaller than or equal to a threshold value, the characters of the title are bordered. This improves the readability of the title. The text decoration unit 1206 outputs the decorated skeleton data, that is, the poster data that has been completely laid out to the impression estimation unit 218.

In S1308, the layout unit 217 determines whether all poster data has been generated. In a case where poster data has been generated for all combinations of skeletons, color scheme patterns, and fonts, the layout processing is ended and the processing flow proceeds to S911. If all the poster data have not been generated, the processing flow returns to S1301 to generate poster data for a combination that has not yet been subjected to the generation.

The process in S910 has been described above. Referring again to FIG. 9, the description is continued.

In S911, the impression estimation unit 218 renders each piece of poster data acquired from the layout unit 217, and associates the estimated impression obtained by estimating the impression of the rendered poster image with the poster data. This makes it possible to evaluate not only the impression of individual elements of the poster such as color schemes and positions, but also the impression of the final poster including laid images and characters. For example, even if the color scheme pattern is the same, the layout can change depending on the skeleton, and thus which color is actually used in how large an area is different depending on the skeleton. Therefore, it is necessary to evaluate the final overall impression of the poster as well as the individual impressions of the color scheme patterns and skeletons.

In S912, the poster selection unit 219 selects a poster to be presented to the user based on the poster data and the estimated impression acquired from the impression estimation unit 218. In this embodiment, the poster selection unit 219 selects a poster that provides a distance smaller than or equal to a predetermined threshold value between the target impression and the estimated impression of the poster. In a case where the number of selected posters is less than the number specified by the poster creation condition specification unit 201, the poster selection unit 219 further selects a missing number of posters in ascending order of the distance between the target impression and the estimated impression of the poster. In the present embodiment, the poster selection unit 219 also selects the missing posters, but this is by way of example and not limitation. For example, in a case where the number of posters selected by the poster selection unit 219 is less than the number of posters to be created, the preview screen 601 may display that the number of posters is insufficient. Alternatively, the poster selection unit 219 may select the missing posters and display them on the preview screen 601 such that the posters whose distance between the target impression and the estimated impression is less than or equal to the threshold value can be distinguished from the posters whose distance is greater than the threshold value. Still alternatively, in the case where the number of selected posters is insufficient, the process may return to S903 and increase the number of selected skeletons, color scheme patterns, and fonts.

In S913, the poster display unit 205 renders the poster data selected by the poster selection unit 219 and outputs the resultant poster image to the display 105. That is, the preview screen 601 in FIG. 6 is displayed.

Above is described the process of creating the posters according to the impression specified by the user.

As described above, according to the present embodiment, it is possible to create a poster that expresses the impression desired by the user. More specifically, in the present embodiment, a plurality of variations of poster candidates can be created according to the target impression by selecting and combining elements that make up the posters, such as skeletons, color scheme patterns, and fonts, based on the target impression. In the creation process, by using a color scheme pattern with colors similar to the main color of the image input by the user, the overall sense of unity of the poster can be achieved. Furthermore, by estimating the overall impression of the poster and selecting a poster with an impression close to the target impression from the group of candidate posters, it is possible to create a poster that meets the user's intentions in terms of not only individual elements, but also the overall impression.

### First Modification of First Embodiment

In the first embodiment described above, the target impression is set using the impression setting slider bars 508 to 511 on the application screen 501, but the method for setting the target impression is not limited to this.

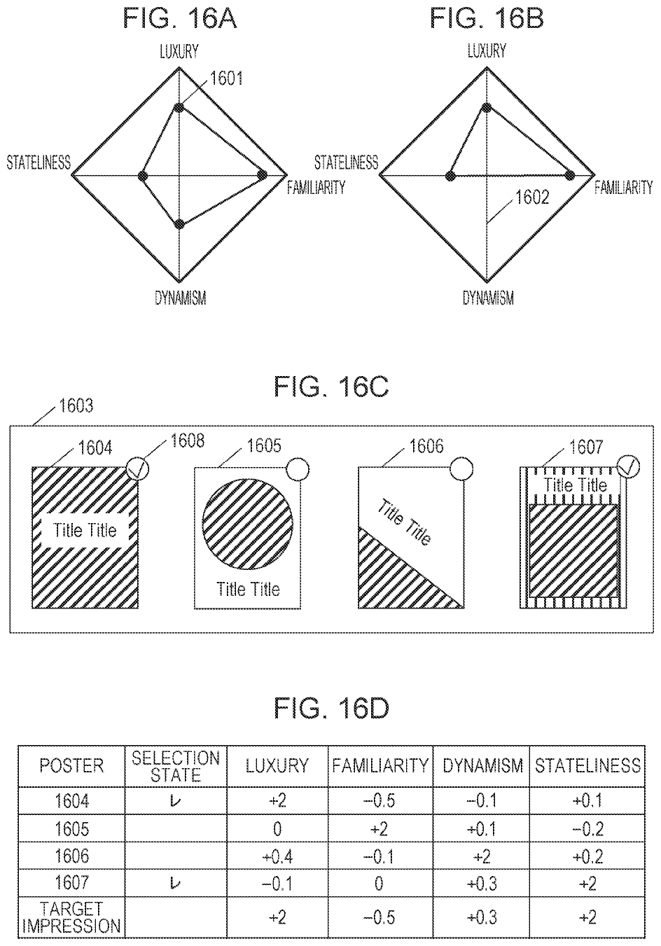

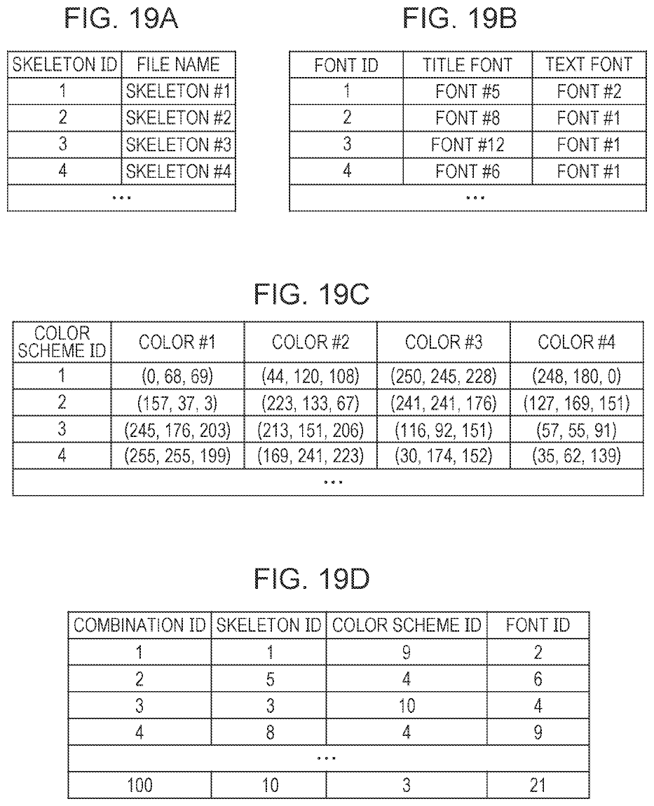

Referring to 16A to 16D, examples of UIs for setting a target impression are described. FIG. 16A illustrates an example of setting a target impression with a UI on a radar chart. By operating a handle 1601 on the radar chart in FIG. 16A, the target impression can be set along each axis. The target impression specification unit 204 acquires a target impression such that −2 is obtained when the handle 1601 is at the center of the UI, and +2 is obtained when it is at an outermost position. In the example shown in FIG. 19A, the target impressions are specified such that luxury=+0.8, familiarity=+1.1, dynamism=−0.1, and stateliness=−0.7. As in this example, the target impression may be expressed as a decimal fraction. FIG. 16B shows an example of a radar chart in which some target impressions are disabled. For example, if the user double-clicks the handle 1601 with the pointing device 107, the target impression of the axis on which the handle is located is disabled. When the user clicks again the axis 1602 of the radar chart with the pointing device 107, the target impression is enabled. In the example in FIG. 16B, although dynamism is disabled, the target impression is the same as that in FIG. 16A, except for dynamism.

FIG. 16C shows an example of a UI for setting a target impression based on images instead of words. In a sample poster display area 1603, poster images 1604 to 1607 are arranged that differ greatly from each other with respect to an impression item. A check box 1608 is displayed for each poster image. If the user turns on a check box 1608 by clicking a poster that is close to a poster the user wants to create by using the pointing device 107, the poster is selected. The target impression specification unit 204 determines the target impression by referring to the impression corresponding to the selected poster image. FIG. 16D illustrates a table representing impressions corresponding to the poster images 1604 to 1607 shown in FIG. 16C and final target impressions. For example, assume that poster images 1604 and 1607 are selected as shown in FIG. 16C. In this case, the target impression specification unit 204 determines, as the target impression, an impression 1613 obtained by synthesizing the impressions 1609 and 1612. In this example, among the impressions corresponding to the selected poster images, the value having the maximum absolute value is taken as the target impression. Although the example described above presents a poster image with a maximum impression value, this is by way of example and not limitation. For example, a poster image may be used in which a plurality of impressions have large values, or poster images may be presented such the number of presented poster images is equal to or greater than the number of impressions. This allows the user to intuitively specify the target impression based on the actual posters instead of using words.

### Second Modification of First Embodiment

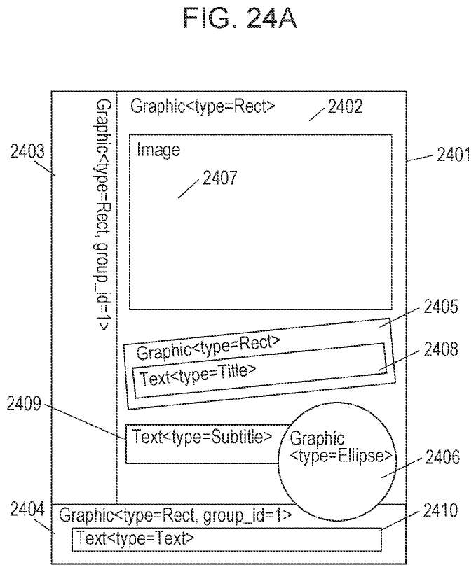

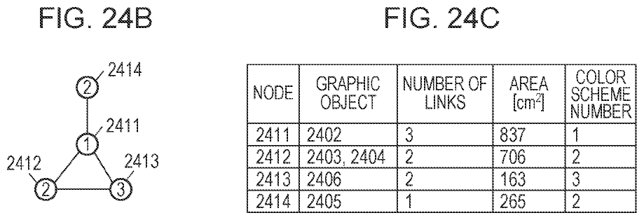

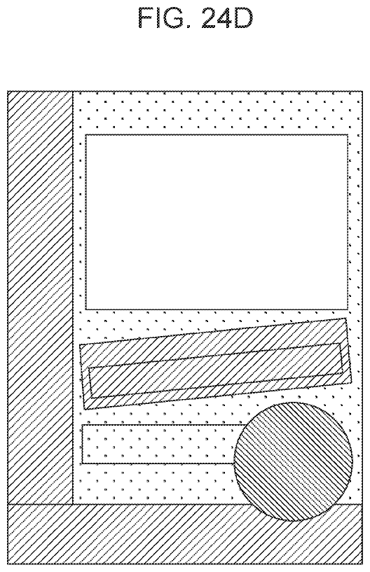

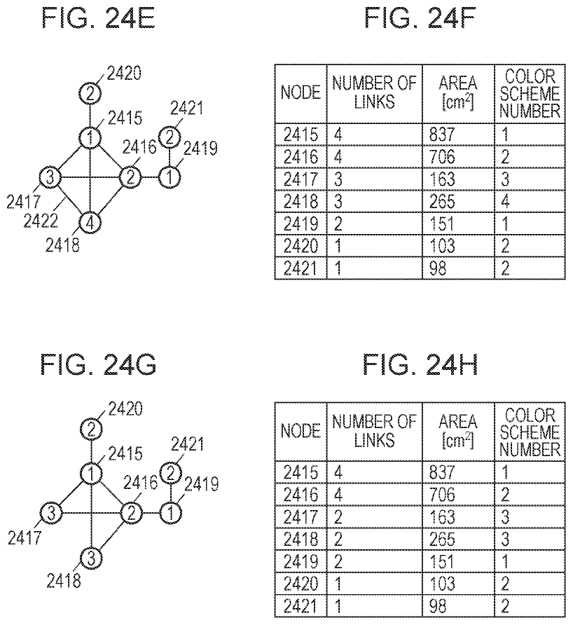

In the first embodiment described above, the color scheme assignment unit 1201 assigns colors according to the area ratio, but the method of assigning colors is not limited to this. For example, colors may be assigned such that adjacent graphic objects are as unlikely to have the same color as possible. Referring to FIGS. 24A to 24H, an example of a method for the color scheme assignment unit 1201 to assign colors to skeletons are described below. FIG. 24A shows a skeleton 2401 assigned color schemes according to the methods described below. The skeleton 2401 includes five graphic objects 2402 to 2406, one image object 2407, and three text objects 2408 to 2410.

First, the color scheme assignment unit 1201 calculates the adjacency relationship between graphic objects. FIG. 24B is a diagram schematically representing the adjacency relationship between graphic objects using nodes and links. Each nodes represents a graphic object, and a link is provided between adjacent graphic objects. The numbers written in the nodes are the color scheme numbers assigned by the method described later. In this example, a node 2411 corresponds to the graphic object 2402, a node 2412 corresponds to the graphic objects 2403 and 2404, a node 2413 corresponds to the graphic object 2406, and a node 2414 corresponds to the graphic object 2405. Note that in FIG. 24A, the graphic objects 2403 and 2404 have the same metadata group ID. The color scheme assignment unit 1201 performs control such that objects with the same group ID are assigned the same color. Therefore, in FIG. 24B, the graphic objects 2403 and 2404 are represented as being included in one node 2412.

Next, the color scheme assignment unit 1201 assigns a color scheme number to each node. FIG. 24C is a table that summarizes information about the nodes shown in FIG. 24B and the assigned color scheme numbers. The color scheme assignment unit 1201 first assigns color scheme numbers to nodes in descending order of the number of links that the node has. In a case where the number of links is the same, color scheme numbers are assigned in descending order of area. In this assignment process, if a color is already assigned to one of adjacent nodes, that color is not assigned to the other node. For example, in FIG. 24C, the node 2412 and the node 2413 have the same number of links, and the node 2412 has a larger area than the node 2413. Therefore, the node 2412 is first assigned a color scheme number. In this assignment, since the adjacent node 2411 has already been assigned a color scheme number 1, the next color scheme number, that is, 2, is assigned to the node 2412. In the assignment to the node 2413, since the adjacent node 2411 is already assigned the color scheme number 1 and the adjacent node 2412 is already assigned the color scheme number 2, a further next color scheme number, that is, 3, is assigned to the node 2413.

Finally, the color scheme assignment unit 1201 assigns colors to the graphic objects according to the color scheme numbers. That is, the color #1 is assigned to the graphic object 2402, the color #2 is assigned to the graphic objects 2403, 2404 and 2405, and the color #3 is assigned to the graphic object 2406. FIG. 24D shows the result of assigning the colors indicated by the color scheme ID #1 shown in FIG. 14B to the skeleton 2401. As a result, adjacent graphic objects are assigned different colors, and thus the original design intent is achieved. Note that in this example, the title of the text object 2408 is assigned the color #4 although it is not shown in FIG. 24D.

In the case of a complicated skeleton, there is a possibility that the number of colors in the color scheme pattern is insufficient. For example, FIG. 24E shows an example of the relationship between nodes and links of a skeleton in which some graphic objects have more than three adjacent graphic objects. In this example shown in FIG. 24E, four colors are required to assign colors to graphic objects such that any adjacent graphic objects are assigned different colors. FIG. 24F shows an example in which color scheme numbers are assigned to the nodes for a case where the adjacency relationship between graphic objects is represented by nodes and links shown in FIG. 24E. A node 2418 is assigned a color scheme number of 4 to avoid assigning the same color scheme numbers to adjacent nodes. In this case, for example, the adjacency length between graphic objects (the length of the side along which adjacent graphic objects are in contact with each other) is calculated and assigned to the link. Then, links are removed sequentially in ascending order of the adjacency length, starting with the link with the smallest adjacency length, until the number of colors is sufficient. FIG. 24G shows an example of the relationship between nodes and links when the link 2415 is removed from the state shown in FIG. 24E. FIG. 24H shows an example of color scheme numbers assigned in the state shown in FIG. 24G. As can be seen, color scheme numbers are assigned such that any adjacent nodes are assigned different color scheme numbers. As a result, even when the number of colors is insufficient, it is possible to assign color schemes while suppressing the influence of assigning the same colors to adjacent graphic objects.

The color scheme patterns having different numbers of colors may be prepared. For example, the color scheme assignment unit 1201 may select only the color scheme patterns including colors the number of which is equal to or greater than the largest color scheme number assigned to the skeleton from the color scheme patterns acqujired from the color sheme pattern selection unit 215. This allows it to select a color scheme pattern suitable for the skeleton. In the present embodiment, links are removed based on the length of adjacency between adjacent graphic objects, but this is by way of example and not limitation. Alternatively, for example, links may be removed based the overlapping area between graphic objects or the ratio of adjoining lengths (the ratio of adjoining lengths to perimeter lengths of graphic objects).

### Second Embodiment

In the first embodiment described above, a skeleton, a color scheme pattern, and a font are selected based on an image and a target impression specified by a user thereby creating a poster A second embodiment discloses an example in which the image selection unit selects an image from a plurality of candidate images specified by a user, based on a target impression and a color scheme pattern. More specifically, first, the color scheme pattern selection unit selects a color scheme pattern that matches the target impression, and then the image selection unit selects an image that matches the selected color scheme pattern. This allows it to select an image that matches both the target impression and the color scheme pattern, and thus a good sense of overall unity can be achieved for a poster without the user having to uniquely specify an image to be used.

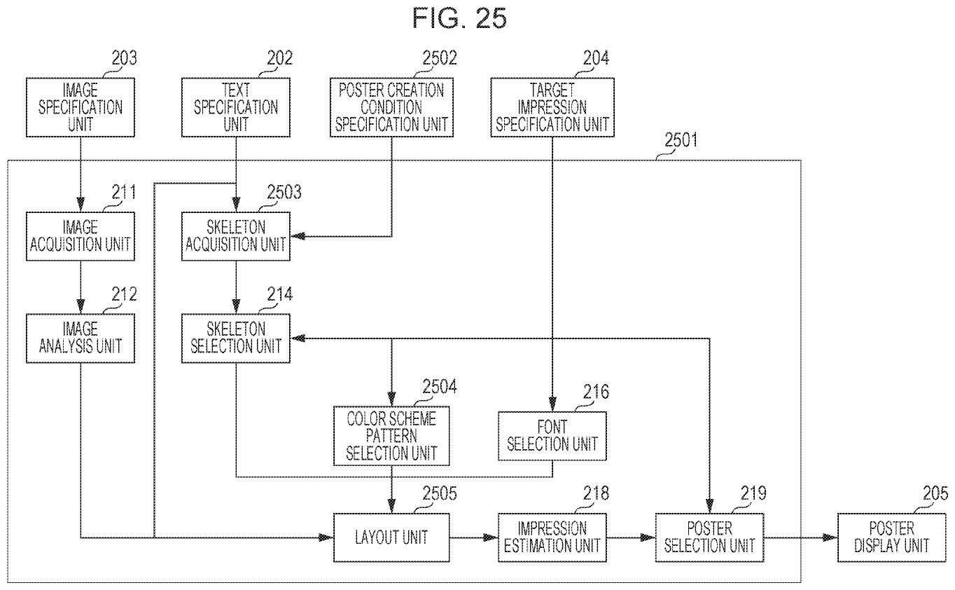

FIG. 25 is a software block diagram of a poster creation application according to the present embodiment. The constituent elements assigned the same reference numbers as those in FIG. 2 perform the same processing as the processing according to the first embodiment described above, and therefore a duplicate description thereof is omitted. Furthermore, the flowchart showing the processing by the poster creation unit 2501 of the poster creation application according to the present embodiment is the same as the flowchart shown in FIG. 9, and therefore, the description thereof is omitted.

In the present embodiment, the poster creation condition specification unit 2502 specifies, as the poster creation conditions, the number of images to be placed on the poster in addition to the size of the poster, the number of posters to be created, and the purpose category. For example, an input field for inputting the number of images is added to the application screen 501, thereby making it possible to accept user input specifying the number of images. Note that the number of images may be a fixed value, or a range of the number of images may be specified.

A candidate image specification unit 2503 specifies a group of images that are candidates for placement on the poster from the group of images stored in the HDD 104. The specifying of a group of images is performed by a user by selecting a plurality of images, for example, via the image specification area 505 of the application screen 501. When the user presses the image addition button 507, the image specification unit 505 displays a dialog screen for selecting a file stored in the HDD 104 and accepts a selection of an image file from the user. On the dialog screen for selecting files, a plurality of image files may be specified, or a directory or other similar file system structure where one or more images are stored may be specified. Alternatively, accompanying information of individual images such as shooting date and time or attribute information may be specified. The candidate image specification unit 2503 outputs the file path of the specified image group to the image acquisition unit 211.

The skeleton acquisition unit 2504 sequentially reads skeleton files from the HDD 104 into the RAM 103, while keeping skeletons that meet the conditions in the RAM 103 and deleting skeletons that do not meet the conditions from the RAM 103. The skeleton acquisition unit 2504, like skeleton acquisition unit 213, determines whether the skeleton size, the purpose category, and the text information match those specified by the poster creation condition specification unit 2502 and the text specification unit 202. Furthermore, the skeleton acquisition unit 2504 determines whether the number of images specified by the poster creation condition specification unit 2502 matches the number of image objects of the skeleton. The skeleton acquisition unit 2504 holds on the RAM 103 the skeleton that satisfies all the conditions.

The color scheme pattern selection unit 2505 acquires, from the HDD 104, a group of color scheme patterns that match the target impression specified by the target impression specification unit 204, and outputs the group of acquired color scheme patterns to the layout unit 2506. The color scheme pattern selection unit 2505 selects a color scheme pattern according to the target impression by referring to a color scheme pattern impression table such as that shown in FIG. 11A, as in the process in S905.

The layout unit 2506 generates poster data by laying out various data on each skeleton acquired from the skeleton selection unit 214. The layout unit 2506 outputs the generated poster data group to the impression estimation unit 218.

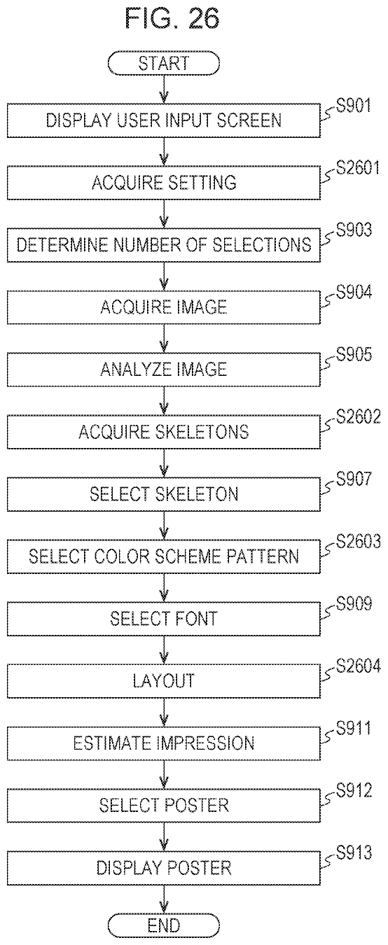

FIG. 26 is a flowchart illustrating a poster creation process performed by the poster creation application according to the present embodiment. The constituent elements assigned the same reference numbers as those in FIG. 9 perform the same processing as the processing according to the first embodiment described above, and therefore a further duplicate description thereof is omitted.

In S2601, the poster creation condition specification unit 2502, the text specification unit 202, the candidate image specification unit 2503, and the target impression specification unit 204 acquire settings from the application screen 501.

In S2602, the skeleton acquisition unit 2504 acquires skeletons from the HDD 104 and loads them into the RAM 103.

In S2603, the color scheme pattern selection unit 2505 acquires from the HDD 104 a group of color scheme patterns that match the target impression specified by the target impression specification unit 204.

In S2604, the layout unit 2506 generates poster data by laying out various data on each skeleton acquired from the skeleton selection unit 214.

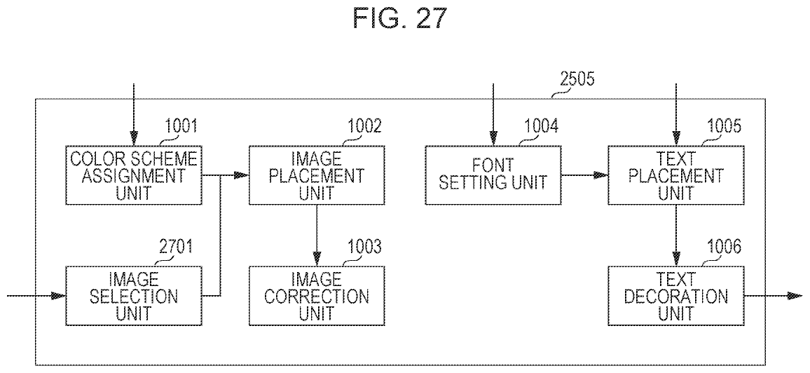

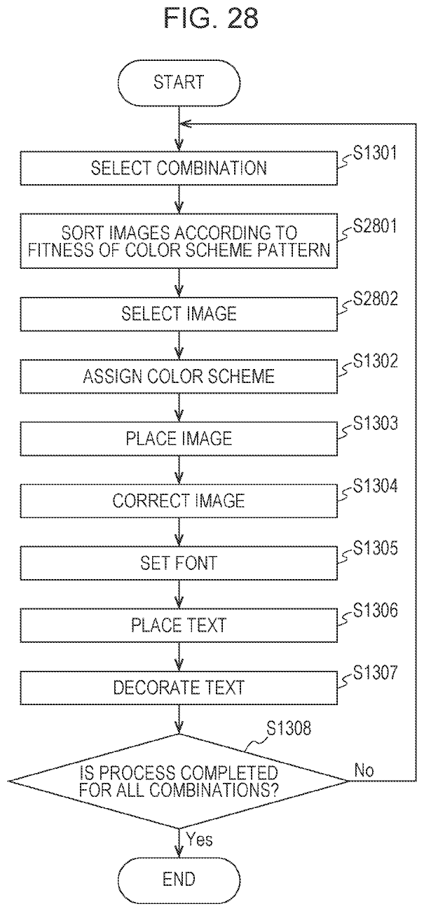

FIG. 27 is a software block diagram illustrating the details of the layout unit 2506 according to the present embodiment. FIG. 28 is a flowchart illustrating details of the layout process in S2604 according to the present embodiment. The constituent units assigned the same reference numbers as those in FIG. 12 or FIG. 13 perform the same processing as the processing according to the first embodiment described above, and therefore a further duplicate description thereof is omitted.

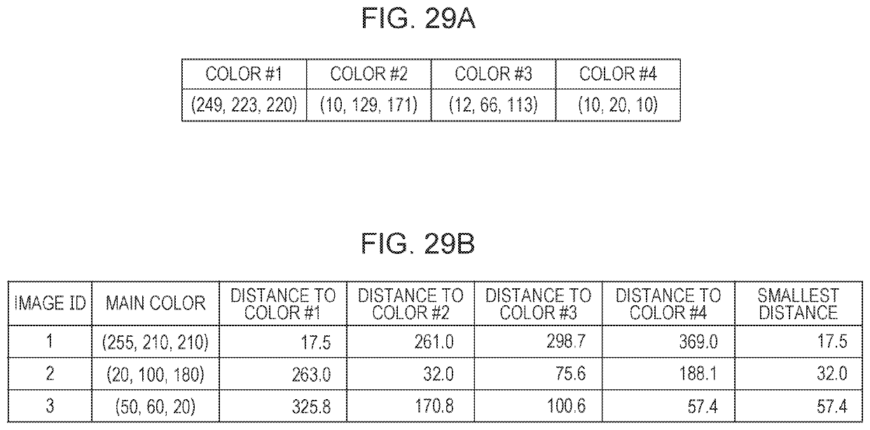

In S2801, the image selection unit 2701 sorts the image data acquired from the image analysis unit 212 according to the color scheme patterns. More specifically, the image selection unit 2701 compares the color scheme patterns with the main color of the image and sorts the images in the order of the colors closest to the color scheme pattern. Referring to FIGS. 29A and 29B, the image selection process is described below. FIG. 29A illustrates an example of a color scheme pattern. FIG. 29B is a diagram for explaining the distance between an image and color schemes. In FIG. 29B, the main color column describes main colors acquired from the image analysis unit 212. Columns “distance to color #1” to “distance to color #4” describe the distances between the main colors and the color scheme patterns shown in FIG. 29A. Note that in the present embodiment, the Euclidean distance in the RGB space is calculated. A smallest distance column represents the smallest distance among the distances between the main color and the colors #1 to #4. The image selection unit 2701 sorts the smallest distances described in the smallest distance column in ascending order.

In S2802, the image selection unit 2701 selects images to be used for the skeleton based on the images sorted in S2801. First, the image selection unit 2701 counts the number of image objects that the skeleton has, and determines the number of images to select. The image selection unit 2701 then selects as many images as necessary from the sorted images. For example, in a case where the number of image objects the skeleton has is one, an image with an image ID of 1 in FIG. 29B is selected. In a case where the number of image objects the skeleton has is two, images with image IDs of 1 and 2 are selected. That is, an image having colors close to colors of the color scheme pattern is preferentially selected, which gives the poster a good sense of overall unity. In the present embodiment, the distance between the main color and the color scheme pattern is given by the smallest of the distances between the main color and the colors in the color scheme pattern, but this is by way of example and not limitation. For example, the average distance may be used. Note that the distance may be determined in other color spaces such as Lab or HSV. Furthermore, in a case where there are a plurality of main colors, the distance between each main color and the color scheme pattern is calculated for all main colors, and the smallest distance is determined.

In the present embodiment, posters are created for all color scheme patterns, but this is by way of example and not limitation.

For example, in a case where the number of images, that satisfy that the distances between the main colors and the color scheme patterns are smaller than or equal to a threshold value, is less than the necessary value, the image selection unit 2701 may skip the poster creation using the color scheme patterns. Thus, by using only the color scheme pattern that matches the image specified by the user, it is possible to achieve a good sense of unity in the poster.

As described above, according to the present embodiment, a color scheme pattern to be used for a poster can be selected in accordance with a target impression, and an image to be used in a poster can be selected in accordance with the selected color scheme pattern. As a result, it is possible to create a poster providing an impression close to the target impression while obtaining the sense of unity of the overall poster without the user having to uniquely determine the image to be used for the poster.

### Third Embodiment

In the first embodiment described above, constituent elements of a poster such as a skeleton, a color scheme pattern, and a font are selected based on an image and a target impression, and the poster is created using the selected elements. In a third embodiment described below, a combination generation unit searches, according to a genetic algorithm, for a combination of constituent elements of a poster that gives an overall impression of the poster close to a target impression. This makes it possible to more flexibly select optimal poster constituent elements for the target impression without pre-calculating a skeleton impression table, a color scheme pattern impression table, or a font impression table.

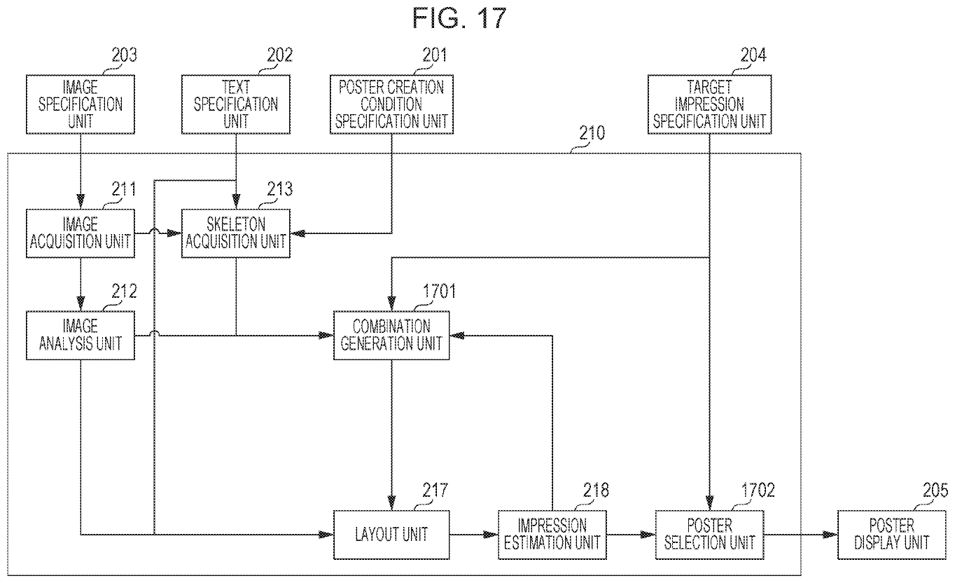

FIG. 17 is a software block diagram of a poster creation application according to a third embodiment. The constituent units assigned the same reference numbers as those in FIG. 2 perform the same processing as the processing according to the first embodiment described above, and therefore a duplicate description thereof is omitted.

The combination generation unit 1701 acquires a group of skeletons from the skeleton acquisition unit 213, poster data and estimated poster impression from the impression estimation unit 218, a target impression from the target impression specification unit 204, and a main color of an image from the image analysis unit 212. The combination generation unit 1701 also acquires a list of color scheme patterns and fonts from the HDD 104. The combination generation unit 1701 generates a combination of constituent elements of a poster (skeletons, color scheme patterns, fonts) used for poster creation. The combination generation unit 1701 outputs the generated combination of poster constituent elements to the layout unit 217.

The poster selection unit 1702 selects a poster whose distance between the estimated impression of the poster and the target impression specified by the target impression specification unit 204 is less than or equal to a threshold value from the poster data acquired from the impression estimation unit 218. The poster selection unit 1702 determines whether the number of selected posters reaches the number of posters to be created specified in the box 514 for specifying the number of posters to be created.

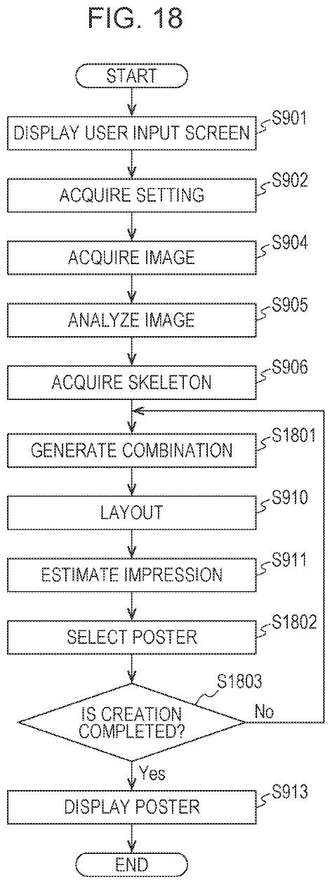

FIG. 18 is a flowchart illustrating a poster creation process performed by the poster creation application according to the present embodiment. The constituent elements assigned the same reference numbers as those in FIG. 9 perform the same processing as the processing according to the first embodiment described above, and therefore a further duplicate description thereof is omitted.

The process in S1801 is described below for two cases: the process is executed for the first time; and the process is executed in a second and subsequent executions in an iterative calculation loop. First, when S1801 is executed for the first time, the combination generation unit 1701 acquires tables of skeletons, color schemes, and fonts used for poster creation. FIGS. 19A to 19D show tables used by the combination generation unit 1701. FIG. 19A shows a list of skeletons acquired by the combination generation unit 1701 from the skeleton acquisition unit 213. FIGS. 19B and 19C show, respectively, a list of fonts and a list of color scheme patterns acquired by the combination generation unit 1701 from the HDD 104. The combination generation unit 1701 generates random combinations from the three tables described above. In this process, the combination generation unit 1701 uses the color scheme pattern table such that only color scheme patterns that match the main color extracted by the image analysis unit 212 are used in generating the combinations. That is, the color difference is calculated between the main color and each of colors #1 to #4 of each color scheme pattern, and only color scheme patterns that have a color difference smaller than or equal to a threshold value for at least one of the colors #1 to #4 are used. As a result, the colors assigned to the poster are the same as the colors contained in the image, and thus the poster as a whole has a sense of unity. In the present embodiment, 100 combinations are generated. FIG. 19D shows a combination table generated according to the present embodiment.

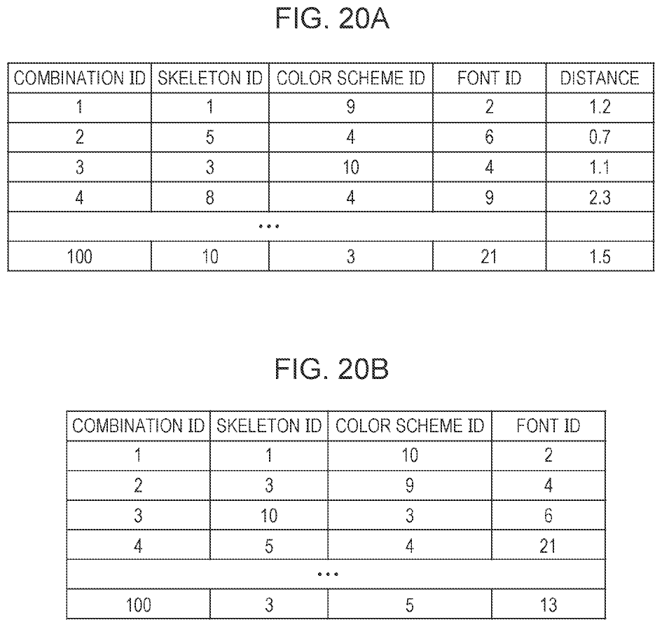

In S1801 in second and subsequent executions in the iterative calculations, the combination generation unit 1701 calculates the distance between the target impression and the estimated poster impression acquired from the impression estimation unit 218, and associates the calculated distance with the combination table. FIG. 20 is a diagram for explaining the process in S1801 performed in second and subsequent executions in the iteration. FIG. 20A shows the result of associating the distance between the estimated poster impression and the target impression with the combination table shown in FIG. 19D. More specifically, the layout unit 217 creates a poster based on the combination table shown in FIG. 19D, and the impression estimation unit 218 estimates the impression of each created poster. The distance column in FIG. 20A describes the distance between the target impression and the estimated impression of the poster created for the combination indicated in the corresponding row. The combination generation unit 1701 generates a new combination table from FIG. 20A. FIG. 20B shows a newly generated combination table. In the present embodiment, the new combination is generated by tournament selection and uniform crossover in a genetic algorithm. In this process, first, N combinations are randomly selected from the table shown in FIG. 20A. For example, N=3. Next, from among the selected combinations, the top two combinations with the shortest distance (that provides impressions close to the target impression) are selected. Finally, a new combination is generated by randomly replacing elements of the combinations (skeleton IDs, color scheme IDs, font IDs) across the two selected combinations. For example, combination IDs 1 and 2 in the table shown FIG. 20B result from the combination IDs 1 and 3 in FIG. 20A with the color scheme IDs interchanged. The total table shown in FIG. 20B is obtained as a result of generating new 100 combinations by repeatedly performing the procedure described above.

Thus, it becomes possible to efficiently search for a combination based on the distance between the target impression and the estimated impression. Although 100 combinations are generated in the present embodiment, the number of combinations is not limited to 100. Furthermore, although the tournament selection and the uniform crossover are used, other methods such as ranking selection, roulette selection, and one-point crossover may be used. In addition, a mutation may be incorporated into the process to make it difficult to fall into a local optimum solution. Although skeletons (arrangements), color scheme patterns, and fonts are used as constituent elements of a poster to be searched, other constituent elements may be used. For example, a plurality of patterns may be prepared to be inserted into the background of a poster, and a determination as to which pattern to use and which not to use may be made by searching. By increasing the number of constituent elements to be searched, it becomes possible to create a greater variety of posters and increase the range of impressions of the posters.

In S1802, the poster selection unit 1702 calculates the distance between the estimated poster impression and the target impression in the same manner as in S1801, and generates a table similar to that shown in FIG. 20A. The poster selection unit 1702 stores in the RAM 103 the poster data whose distance from the target impression is smaller than or equal to a threshold value.

In S1803, the poster selection unit 1702 determines whether the number of poster data stored in S1802 reaches the number of posters to be created specified in the box 514 for specifying the number of posters to be created. In a case where the number reaches the specified number of posters to be created, the poster creation process is ended. However, in a case where the number has not yet reached the specified number of posters to be created, the processing flow returns to S1801.

In the present embodiment, the genetic algorithm is used to search for combinations of poster constituent elements, but the search method is not limited to this, and other search methods such as a neighborhood search method, a tab search method, or the like may be used.

As described above, according to the present embodiment, a combination of constituent elements to be used for a poster is searched for while selecting a color scheme pattern in accordance with the main color of the image. This makes it possible to create a poster such that the overall impression of the created poster is close to the target impression while achieving the sense of unity of the entire poster. This is particularly effective when a poster is created in accordance with an image and text information input by a user. For example, consider a case where it is desired to create a poster such that an image has a dynamic impression but the poster as a whole has a calm impression. In the present embodiment, it is possible to evaluate the overall impression of the poster and search for a combination of a skeleton, a color scheme pattern, and a font that provides an impression close to a target impression. Therefore, the elements of the poster may be controlled depending on the image. For example, to reduce the impact of a particular image, a skeleton with a small image area and/or a more subdued font or color scheme may be used. According to the present embodiment, it is possible to flexibly find a combination of constituent elements that are optimal for the overall impression of the poster, and it is possible to create posters with various variations that are close to the target impression.

### Fourth Embodiment

In the examples according to the first, second, or third embodiments, a poster is created by controlling constituent elements of the poster based on the target impression. A fourth embodiment discloses an example in which templates obtained by combining skeletons, color scheme patterns, and fonts are prepared in advance, and a poster is created only by the layout unit setting an image and text information. This makes it possible to create a poster that matches the target impression by performing simpler processing.

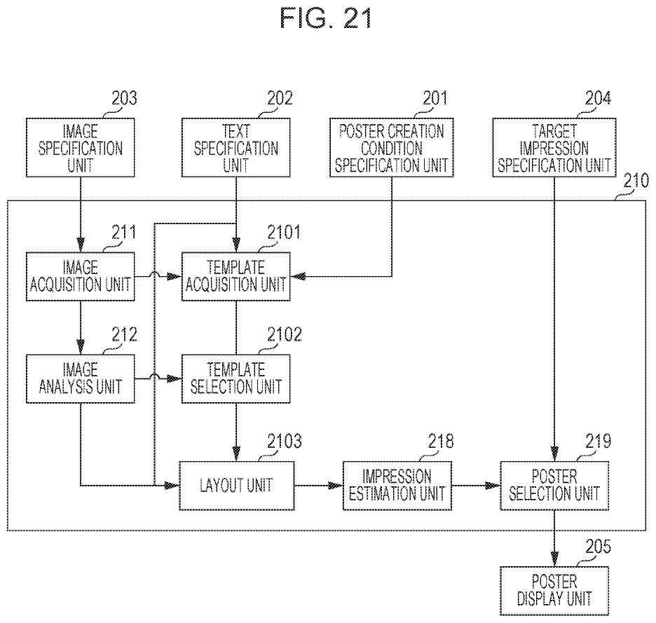

FIG. 21 is a software block diagram of a poster creation application according to a fourth embodiment. The constituent elements assigned the same reference numbers as those in FIG. 2 perform the same processing as the processing according to the first embodiment described above, and therefore a duplicate description thereof is omitted.

A template acquisition unit 2101 acquires from the HDD 104 a group of templates that meet the conditions specified by poster creation condition specification unit 201, the text specification unit 202, and the image acquisition unit 211. In the present embodiment, the template refers to a skeleton for which a color scheme and a font have been set in advance. The template acquisition unit 2101 outputs the acquired group of templates to a template selection unit 2102.

The template selection unit 2102 selects one or more templates that use a color similar to the main color acquired from the image analysis unit 212 from the templates acquired from the template acquisition unit 2101, and outputs the selected templates to the layout unit 2103.

The layout unit 2103 generates poster data by laying out the image obtained from the image analysis unit 212 and the text obtained from the text specification unit 202 on each template acquired from the template selection unit 2102. The layout unit 2103 outputs the generated poster data to the impression estimation unit 218.

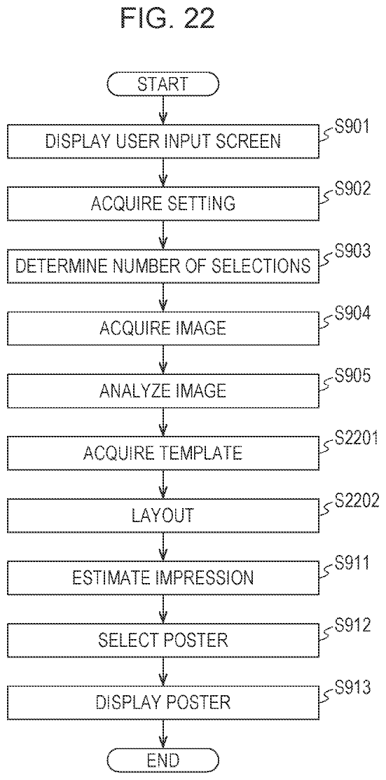

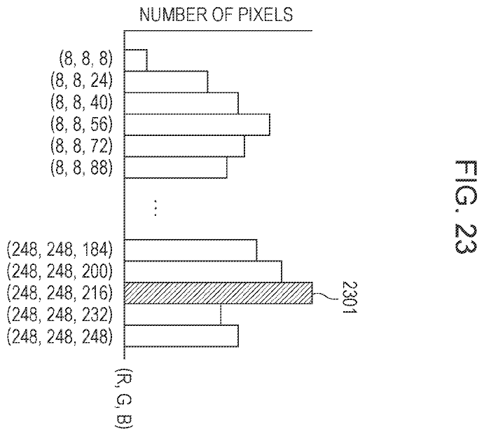

FIG. 22 is a flowchart illustrating a poster creation process performed by the poster creation application according to the present embodiment. The constituent elements assigned the same reference numbers as those in FIG. 9 perform the same processing as the processing according to the first embodiment described above, and therefore a further duplicate description thereof is omitted.

In S1801, the template acquisition unit 2101 acquires a template that meets various setting conditions. In this example, it is assumed that templates are described such that each template is described in one file and stored in the HDD 104. The template acquisition unit 2101, like the skeleton acquisition unit 213, sequentially reads template files from the HDD 104 into the RAM 103, while keeping templates that meet the setting conditions in the RAM 103 and deleting templates that do not meet the conditions from the RAM 103.

In S1802, the template selection unit 2102 selects one or more templates that use a color similar to the main color acquired from the image analysis unit 212 from the templates acquired from the template acquisition unit 2101. More specifically, the color difference between the main color and a color set in a graphic object in each template is calculated, and only templates including a graphic object having a color difference smaller than or equal to a threshold value are selected.

In S1803, the layout unit 2103 creates posters by setting an image and text information for all templates acquired from the template selection unit 2102. The setting of the image is performed in a similar manner to that by the image placement unit 902, and the setting of the text information is similar to that by the text placement unit 905, and thus duplicate descriptions thereof are omitted.

As described above, according to the present embodiment, by preparing templates in advance on which various color schemes and fonts are set, it is possible to create a poster that provides an impression close to the target impression only by performing simple processing.

According to the embodiments described above, it is possible to appropriately create a poster that matches an impression intended by a user while matching between an image and an overall color scheme of the poster is achieved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-104048, filed Jun. 28, 2022, which is hereby incorporated by reference herein in its entirety.

What is claimed is:

1. An information processing apparatus comprising:
at least one processor; and
a memory that stores a program which, when executed by the at least one processor, causes the at least one processor to function as:
an image acquisition unit configured to acquire an image;
an accepting unit configured to accept a target impression from a user;
a selection unit configured to select a color scheme pattern based on a color included in the image and the target impression; and
a poster creation unit configured to create a poster based on the image and the color scheme pattern.

2. The information processing apparatus according to claim 1, wherein the selection unit identifies a main color included in the image, and selects a color scheme pattern based on the identified main color and the target impression.

3. The information processing apparatus according to claim 1, further comprising a display control unit configured to display a screen for accepting a target impression,
wherein the accepting unit accepts the target impression via the screen.

4. The information processing apparatus according to claim 1, wherein the poster creation unit creates a poster such that a difference between an impression of the poster and a target impression is smaller than or equal to a predetermined threshold value.

5. The information processing apparatus according to claim 1, further comprising a character acquisition unit configured to acquire a character,
wherein the poster creation unit creates a poster based on the image, the character, and the target impression.

6. The information processing apparatus according to claim 1, wherein the poster creation unit creates a poster by changing a position of one or more of an image, a character, and a graphic included in the poster based on the target impression.

7. A control method for an information processing apparatus, comprising:
acquiring an image;
accepting a target impression from a user;
selecting a color scheme pattern based on a color included in the image and the target impression; and
creating a poster based on the image and the color scheme pattern.

8. The control method for the information processing apparatus according to claim 7, wherein the selecting includes identifying a main color included in the image, and selecting a color scheme pattern based on the identified main color and the target impression.

9. The control method for the information processing apparatus according to claim 7, further comprising displaying a screen for accepting a target impression,
wherein the accepting includes accepting the target impression via the screen.

10. The control method for the information processing apparatus according to claim 7, wherein the poster is created such that a difference between an impression of the poster and a target impression is smaller than or equal to a predetermined threshold value.

11. The control method for the information processing apparatus according to claim 7, further comprising acquiring a character,
wherein the poster is created based on the image, the character, and the target impression.

12. The control method for the information processing apparatus according to claim 7, wherein the poster is created by changing a position of one or more of an image, a character, and a graphic included in the poster based on the target impression.

13. A non-transitory computer-readable storage medium storing a program configured to cause a computer of an information processing apparatus to function as:
an image acquisition unit configured to acquire an image;
an accepting unit configured to accept a target impression from a user;
a selection unit configured to select a color scheme pattern based on a color included in the image and the target impression; and
a poster creation unit configured to create a poster based on the image and the color scheme pattern.
